(19) United States
(12) Patent Application Publication
(10) Pub. No.: US 2019/0379078 A1
(43) Pub. Date: Dec. 12, 2019

(54) POLYOXOVANADATE-ALKOXIDE CLUSTERS: CHARGE CARRIERS FOR NON-AQUEOUS REDOX FLOW BATTERIES

(71) Applicants: University of Rochester, Rochester, NY (US); The Research Foundation for The State University of New York, Amherst, NY (US)

(72) Inventors: Ellen M. Matson, Fairport, NY (US); Lauren E. Vangelder, Spencerport, NY (US); Madushani A. Kosswattaarachchi, Buffalo, NY (US); Timothy R. Cook, Amherst, NY (US)

(21) Appl. No.: 16/002,616

(22) Filed: Jun. 7, 2018

(51) Int. Cl. H01M 8/18; H01M 8/04082

(52) U.S. Cl. CPC H01M 8/188; H01M 2300/0025; H01M 8/04201

(57) ABSTRACT

A non-aqueous redox flow battery includes a negative electrode disposed within a non-aqueous liquid negative electrolyte tank. A positive electrode is disposed within a non-aqueous liquid positive electrolyte tank. A semi-permeable membrane is interposed between the non-aqueous liquid negative electrolyte tank and the non-aqueous liquid positive electrolyte tank. At least one of the non-aqueous liquid negative electrolyte tank or the non-aqueous liquid positive electrolyte tank includes POV-alkoxide clusters.

### FIELD OF THE APPLICATION

The application relates to a redox flow battery, and particularly to a non-aqueous redox flow battery.

### BACKGROUND

Growing global energy demands drive the need for technologies that can address energy storage at the grid and microgrid scale, thereby enabling the incorporation of distributed renewable resources such as solar and wind. Redox flow batteries (RFBs) are an attractive approach, in that they decouple power and energy densities for straightforward scaling based on electrode stack size and reservoir volume.

### SUMMARY

According to one aspect, a non-aqueous redox flow battery includes a negative electrode disposed within a non-aqueous liquid negative electrolyte tank. A positive electrode is disposed within a non-aqueous liquid positive electrolyte tank. A semi-permeable membrane is interposed between the non-aqueous liquid negative electrolyte tank and the non-aqueous liquid positive electrolyte tank. At least one of the non-aqueous liquid negative electrolyte tank or the non-aqueous liquid positive electrolyte tank includes POV-alkoxide clusters.

In one embodiment, at least one of the non-aqueous liquid negative electrolyte tank or the non-aqueous liquid positive electrolyte tank includes 6-V₆O₇(OEt)₁₂.

In another embodiment, there is substantially no decomposition of an active species throughout a cycling of the 6-V₆O₇(OEt)₁₂.

In yet another embodiment, a substitution of a bridging alkoxide moieties of methoxide provides enhanced solubility of a metal oxide cluster.

In yet another embodiment, a substitution of a bridging alkoxide moieties of ethoxide provides enhanced stability.

In yet another embodiment, a stability of POV-alkoxide clusters is controlled by a facile alkoxide substitution which substantially preserves a multi-electron redox activity of a hexavanadate core.

In yet another embodiment, a substitution of bridging ethoxide ligands of 6-V₆O₇(OEt)₁₂ enhances electrochemical properties of the hexavanadate core, resulting in a substantially stable charge carrier.

In yet another embodiment, a hexavanadate cluster substantially prevents membrane crossover.

In yet another embodiment, the hexavanadate cluster includes a plurality of POV-alkoxide clusters which are substantially resistant to membrane crossover.

In yet another embodiment, the POV-alkoxide clusters include a ligand substitution from methoxide to ethoxide.

In yet another embodiment, a battery cell efficiency is improved by a ligand substitution of bridging alkoxides on a self-assembled cluster.

In yet another embodiment, a plurality of POV-alkoxide clusters cycle two electrons at both the positive electrode and the negative electrode.

In yet another embodiment, a plurality of POV-alkoxide clusters manufactured by a one-step synthesis process.

The foregoing and other aspects, features, and advantages of the application will become more apparent from the following description and from the claims.

### BRIEF DESCRIPTION OF THE DRAWINGS

The features of the application can be better understood with reference to the drawings described below, and the claims. The drawings are not necessarily to scale, emphasis instead generally being placed upon illustrating the principles described herein. In the drawings, like numerals are used to indicate like parts throughout the various views.

FIG. 1A shows a first metal coordination complex and polyoxometalates charge carrier for a non-aqueous redox flow battery (NRFB);

FIG. 1B shows a second metal coordination complex and polyoxometalates charge carrier for a NRFB;

FIG. 1C shows a third metal coordination complex and polyoxometalates charge carrier for a NRFB;

FIG. 1D shows a fourth metal coordination complex and polyoxometalates charge carrier for a NRFB;

FIG. 1E shows an exemplary self-assembled metal oxide cluster with Lindqvist POV-alkoxide clusters as a charge carrier for a NRFB;

FIG. 1F shows another exemplary self-assembled metal oxide cluster with Lindqvist POV-alkoxide clusters as a charge carrier for a NRFB;

FIG. 1G shows a table of electrochemical properties of exemplary self-assembled metal oxide clusters with Lindqvist POV-alkoxide clusters;

FIG. 2 is a plot that shows cyclic voltammograms for V₆O₇(OMe)₁₂ and 6-V₆O₇(OEt)₁₂ metal oxide cluster charge carriers with Lindqvist POV-alkoxide clusters;

FIG. 3 is a graph that shows potential curves for 1-V₆O₇(OMe)₁₂ metal oxide cluster charge carriers with Lindqvist POV-alkoxide clusters for cycles 2-4;

FIG. 4 is a plot that shows cyclic voltammetry (CV) for 1-V₆O₇(OMe)₁₂ metal oxide cluster charge carriers with Lindqvist POV-alkoxide clusters before and after cycling;

FIG. 5 is a graph that shows potential curves for 6-V₆O₇(OEt)₁₂ metal oxide cluster charge carriers with Lindqvist POV-alkoxide clusters for cycles 2-4;

FIG. 6 is a plot that shows CV for 16-V₆O₇(OEt)₁₂ metal oxide cluster charge carriers with Lindqvist POV-alkoxide clusters before and after cycling;

FIG. 7 is a graph that shows an extent of cross over for V(acac)₃ for 1-V₆O₇(OMe)₁₂ and 6-V₆O₇(OEt)₁₂ metal oxide cluster charge carriers with Lindqvist POV-alkoxide clusters for cycles 2-4;

FIG. 8 is a plot that shows cyclic voltammetry (CV) cycling of 1-V₆O₇(OMe)₁₂;

FIG. 9A is a plot of CV cycling of 1-V₆O₇(OMe)₁₂ at various scan rates;

FIG. 9B is a plot of CV cycling of 1-V₆O₇(OMe)₁₂ for an exemplary redox event;

FIG. 10A is a plot of iₚ vs. (v)^{1/2} for 1-V₆O₇(OMe)₁₂;

FIG. 10B is a plot of ΔE vs. (v)^{1/2} for 1-V₆O₇(OMe)₁₂;

FIG. 11A is another exemplary plot of iₚ vs. (v)^{1/2} for 1-V₆O₇(OMe)₁₂;

FIG. 11B is another exemplary plot of ΔE vs. (v)^{1/2} for 1-V₆O₇(OMe)₁₂;

FIG. 12A is yet another exemplary plot of iₚ vs. (v)^{1/2} for 1-V₆O₇(OMe)₁₂;

FIG. 12B is yet another exemplary plot of ΔE vs. (v)^{1/2} for 1-V₆O₇(OMe)₁₂;

FIG. 13A is yet another exemplary plot of iₚ vs. (11)^{1/2} for 1-V₆O₇(OMe)₁₂;

FIG. 13B is yet another exemplary plot of ΔE vs. (v)^{1/2} for 1-V₆O₇(OMe)₁₂;

FIG. 14A is a plot of CV cycling of 2-V₆O₇(OMe)₁₂²⁻;

FIG. 14B is a graph of an absorption spectra of 2-V₆O₇(OMe)₁₂²⁻;

FIG. 15A is a plot of CV cycling of 3-V₆O₇(OMe)₁₂⁻;

FIG. 15B is a graph of an absorption spectra of 3-V₆O₇(OMe)₁₂⁻;

FIG. 16A is a plot of CV cycling of 1-V₆O₇(OMe)₁₂;

FIG. 16B is a graph of an absorption spectra of 1-V₆O₇(OMe)₁₂;

FIG. 17A is a plot of CV cycling of 4-V₆O₇(OMe)₁₂⁺;

FIG. 17B is a graph of an absorption spectra of 4-V₆O₇(OMe)₁₂⁺;

FIG. 18A is a graph of bulk oxidation current vs. time of 1-V₆O₇(OMe)₁₂ in MeCN;

FIG. 18B is a bulk oxidation CV plot of 1-V₆O₇(OMe)₁₂ in MeCN;

FIG. 19A is a graph of absorbance spectra of 2-V₆O₇(OMe)₁₂²⁻;

FIG. 19B is a Beer's Law plot of absorbance of 2-V₆O₇(OMe)₁₂²⁻;

FIG. 20A is a graph of absorbance spectra of 3-V₆O₇(OMe)₁₂⁻;

FIG. 20B is a Beer's Law plot of absorbance of 3-V₆O₇(OMe)₁₂⁻;

FIG. 21A is a graph of absorbance spectra of 1-V₆O₇(OMe)₁₂;

FIG. 21B is a Beer's Law plot of absorbance of 1-V₆O₇(OMe)₁₂;

FIG. 22A is a graph of absorbance spectra of 4-V₆O₇(OMe)₁₂⁺;

FIG. 22B is a Beer's Law plot of absorbance of 4-V₆O₇(OMe)₁₂⁺;

FIG. 23 is a plot of CV of the catholyte 1-V₆O₇(OMe)₁₂;

FIG. 24 is a plot of CV cycling of 6-V₆O₇(OEt)₁₂;

FIG. 25A is a plot of iₚ vs. (v)^{1/2} for 6-V₆O₇(OEt)₁₂;

FIG. 25B is a plot of ΔE vs. (v)^{1/2} for 6-V₆O₇(OEt)₁₂;

FIG. 26A is another exemplary plot of iₚ vs. (v)^{1/2} for 6-V₆O₇(OEt)₁₂;

FIG. 26B is another exemplary plot of ΔE vs. (v)^{1/2} for 6-V₆O₇(OEt)₁₂;

FIG. 27A is yet another exemplary plot of iₚ vs. (v)^{1/2} for 6-V₆O₇(OEt)₁₂;

FIG. 27B is yet another exemplary plot of ΔE vs. (v)^{1/2} for 6-V₆O₇(OEt)₁₂;

FIG. 28A is yet another exemplary plot of iₚ vs. (v)^{1/2} for 6-V₆O₇(OEt)₁₂;

FIG. 28B is yet another exemplary plot of ΔE vs. (v)^{1/2} for 6-V₆O₇(OEt)₁₂;

FIG. 29A is a graph of absorbance spectra of 7-V₆O₇(OEt)₁₂²⁻;

FIG. 29B is a Beer's Law plot of absorbance of 7-V₆O₇(OEt)₁₂²⁻;

FIG. 30A is a graph of absorbance spectra of 8-V₆O₇(OEt)₁₂⁻;

FIG. 30B is a Beer's Law plot of absorbance of 8-V₆O₇(OEt)₁₂⁻;

FIG. 31A is a graph of absorbance spectra of 6-V₆O₇(OEt)₁₂;

FIG. 31B is a Beer's Law plot of absorbance of 6-V₆O₇(OEt)₁₂;

FIG. 32A is a graph of absorbance spectra of 9-V₆O₇(OEt)₁₂⁺;

FIG. 32B is a Beer's Law plot of absorbance of 9-V₆O₇(OEt)₁₂⁺;

FIG. 33A is a graph of absorbance spectra of 10-V₆O₇(OEt)₁₂²⁺;

FIG. 33B is a Beer's Law plot of absorbance of 10-V₆O₇(OEt)₁₂²⁺;

FIG. 34A is a graph of UV-Vis characterization of redox isomers of 6-V₆O₇(OEt)₁₂;

FIG. 34B is a graph of IR characterization of redox isomers of 6-V₆O₇(OEt)₁₂;

FIG. 35A is a plot of CV cycling of 7-V₆O₇(OEt)₁₂²⁻;

FIG. 35B is a graph of an absorption spectra of 7-V₆O₇(OEt)₁₂²⁻;

FIG. 36A is a plot of CV cycling of 8-V₆O₇(OEt)₁₂⁻;

FIG. 36B is a graph of an absorption spectra of 8-V₆O₇(OEt)₁₂⁻;

FIG. 37A is a plot of CV cycling of 6-V₆O₇(OEt)₁₂;

FIG. 37B is a graph of an absorption spectra of 6-V₆O₇(OEt)₁₂;

FIG. 38A is a plot of CV cycling of 9-V₆O₇(OEt)₁₂⁺;

FIG. 38B is a graph of an absorption spectra of 9-V₆O₇(OEt)₁₂⁺;

FIG. 39A is a plot of CV cycling of 10-V₆O₇(OEt)₁₂²⁺;

FIG. 39B is a graph of an absorption spectra of 10-V₆O₇(OEt)₁₂²⁺;

FIG. 40A is a graph of bulk oxidation current vs. time of 1-V₆O₇(OEt)₁₂ in MeCN;

FIG. 40B is a bulk oxidation CV plot of 1-V₆O₇(OEt)₁₂ in MeCN;

FIG. 41 shows an exemplary H-cell; and

FIG. 42 shows an exemplary non-aqueous polyoxovanadate-alkoxide redox flow battery.

### DETAILED DESCRIPTION

This Application is in four parts.

Part 1—Introduction

Part 2—Results and Discussion

Part 3—Conclusion

Part 4—Supplementary Information

In the description, other than the bolded paragraph numbers, non-bolded square brackets (“[ ]”) refer to the citations listed hereinbelow.

### PART 1—INTRODUCTION

Growing global energy demands drive the need for technologies that can address energy storage at the grid and microgrid scale, thereby enabling the incorporation of distributed renewable resources such as solar and wind. [1] Redox flow batteries (RFBs) are an attractive approach, in that they decouple power and energy densities for straightforward scaling based on electrode stack size and reservoir volume. Unlike secondary batteries that contain solid-phase electrolytes and migratory ions as charge carriers, RFBs take advantage of electrolyte solutions typically consisting of a solvent, a supporting electrolyte, and an electroactive species that can cycle in its redox states. [1-3] To date, viable devices have focused on aqueous electrolytes, which use inorganic salts as charge carriers. [2] However, the narrow electrochemical window of water limits aqueous systems to a maximum attainable energy density of 130 kJ/L. [4]

Non-aqueous redox-flow batteries (NRFBs) can circumvent this limitation of aqueous systems, as solvent breakdown occurs only at extreme potentials. [5,6] The use of non-aqueous media in a NRFB enables use of a wide library of active species, spanning molecules and materials, that are soluble in organic solutions. [5] There are a myriad of small molecules that exhibit reversible redox chemistry, especially on short time scales.

Computational methods [7] and physical organic chemistry [8] have been employed to narrow the scope of charge carriers to great effect; however, these studies have largely centred on redox-active organic molecules, in part due to the computational accessibility of such structures.

A complementary physical inorganic strategy is equally powerful as a means to navigate the rich molecular space of redox active complexes and clusters. Coordination compounds have the added benefit over organic molecules of accessible d-orbitals on the metal centre, resulting in a series of charge states that range wide redox potentials. [9-11] In such systems, it is possible to systematically tune physicochemical properties of relevance to NRFBs that include solubility, stability, and redox properties (i.e. reduction potentials and multi-electron transfer). These characteristics directly influence the energy density of an RFB, owing to the equation:

E_{U}=½nV_{cell}C_{active}F (1)

where Eᵤ is volumetric energy density, n is the number of electrons transferred, V_{cell} is the average cell voltage, C_{active} is the concentration of the active species, and F is Faraday's constant. [3] There are notable examples of using ligand design to enhance solubility, manifesting in higher C_{active} values. For example, a suite of M(acac)₃ (M=V, Cr; acac=acetylacetonate-based ligands) complexes have been explored that span over four orders of magnitude in solubility. [12] This strategy is not limited to a single coordination environment, as molecular solubilities have been similarly enhanced on metal-polypyridyl complexes using pendant ligand functionalization. [13-23] Additional investigations into molecular modifications for improved energy densities of charge carriers include examples citing the use of redox-active ligands in conjunction with metal ions for the generation of metal coordination compounds with large degrees of separation between redox waves. [13-25] Most recently, the stability of metal coordination complexes has been addressed by the use of tridentate scaffolds. [8] It is evident from the evolution of charge-carriers in recent years that synthetic chemistry is crucial for the development of optimal electroactive materials for new NRFB technologies.

Exploiting the modular nature of transition metal complexes for RFBs is particularly effective when targeting multimetallic clusters such as polyoxometalates (POMs). These clusters consist of three or more transition metal oxyanions, linked together by bridging oxide units (O²⁻) to form three-dimensional structures, and are typically generated through high-yielding, self-assembly pathways. [26] POMs have found many applications in the fields of catalysis and energy storage due to their unique physical and electrochemical properties. [27-31] One exciting use of these polynuclear systems is their ability to serve as charge carriers for aqueous RFBs. [32] By comparison, the area of non-aqueous redox flow battery development is underdeveloped for these systems. In seminal work, Anderson et. al. made efforts to translate their aqueous POM charge-carrier, [SiV₃W₉O₄₀]⁷⁻, to non-aqueous conditions, but found that the cluster exhibited minimal solubility and significant electrochemical instability in organic solvents. [33] As described in more detail hereinbelow, we have identified new metal-oxide clusters to exploit the advantageous properties of POMs, in combination with the enhanced potential windows of organic media.

Recent studies from Barteau et. al. highlights the multi-electron redox processes and broad potential windows of POMs, suggesting that with suitable molecular modifications, these polynuclear constructs could yield energy dense NRFB electrolytes. [34, 35] One such approach to the generation of metal-oxide clusters that meet the requirements of NRFB charge carriers is the integration of bridging alkoxide ligands (OR⁻) into the POM scaffold. This simple synthetic modification results in a retained homogeneity of the polynuclear clusters across all oxidation states, rendering POV-alkoxide clusters independent of counterions that typically govern the solubility of POMs. [36, 37] In addition to providing opportunities to modify the solubility of these systems (raising C_{active}), the substitution of bridging alkoxide ligands can further tune the redox chemistry of the metal-oxide clusters, leading to increased electrochemical windows for these clusters (larger V_{cell}). [32, 38] Additionally, although not included in equation (1), an important aspect for practical implementation as an active species in RFB technology is long-term stability across all charge-states. [39, 40] The ability to synthetically install ligands in a POM provides a direct route to affect chemical and redox stability. This molecular modification can be systematically controlled, thus providing opportunities to define structure-activity relationships that govern the redox behaviour of relevance to electrochemical energy storage.

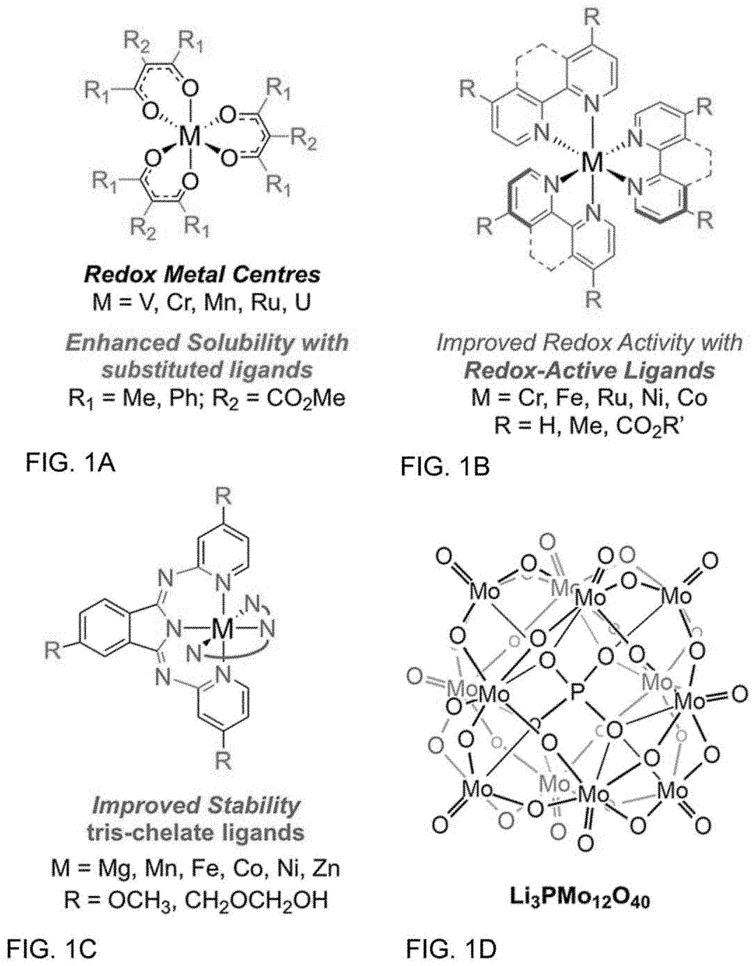

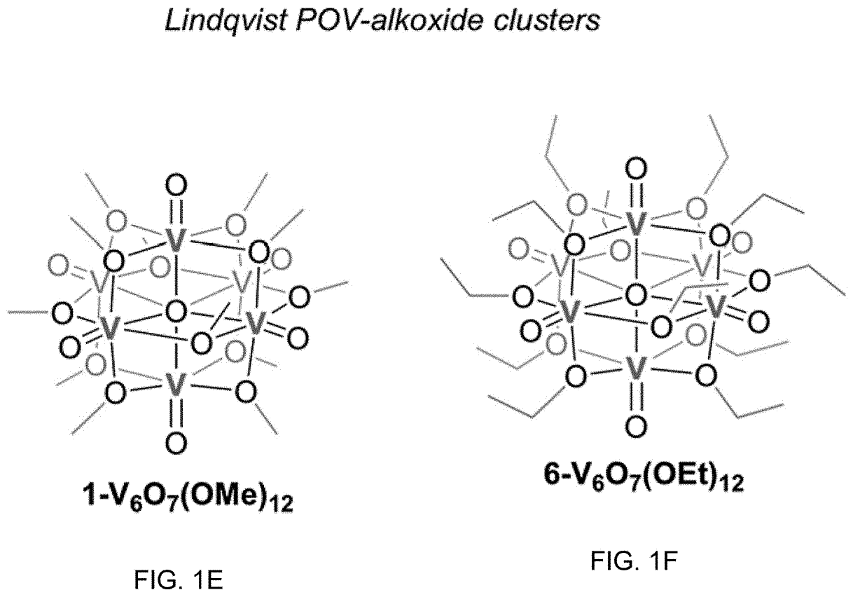

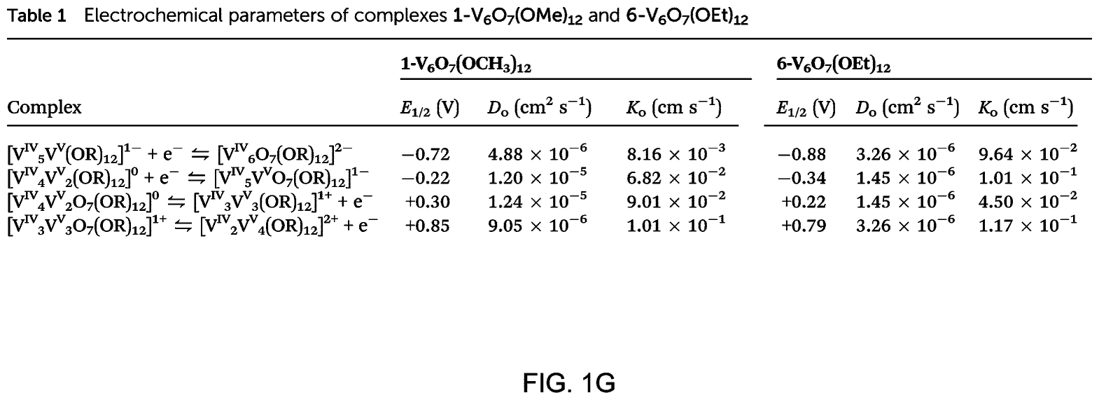

This Application describes compositions of mixed-valent, polyoxovanadate-alkoxide (POV-alkoxide) clusters, [V₆O₇(OR)₁₂] (R═CH₃, C₂H₅), whose bridging alkoxide ligands may be readily swapped from methoxide [41] to ethoxide (FIG. 1E, FIG. 1F). [42, 43] Both hexavanadate cores have been characterized to evaluate their potential as NRFB charge carriers. Whereas the methoxide-functionalized polyoxovanadate cluster results in only modest energy storage potential, owing to its oxidative instability that limits the practical V_{cell}, molecular modification to the ethoxide derivative provides access to the full multi-electron redox chemistry of the Lindqvist core.

This Application describes a physical inorganic approach to the manipulation of molecular properties of POMs through the combination of synthetic chemistry and electrochemical analysis. The new composition is in a highly cyclable inorganic charge carrier for NRFBs, derived from earth-abundant elements and obtained from high-yielding, self-assembly methods.

### PART 2—RESULTS AND DISCUSSION

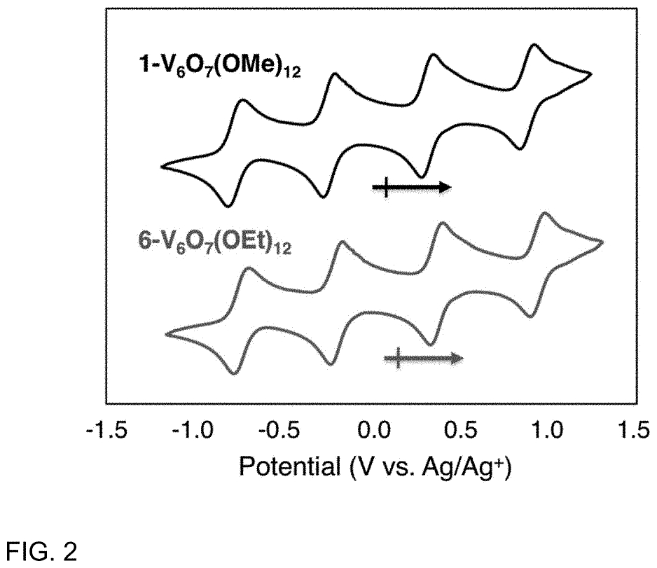

Physical and Electronic Properties of 1-V₆O₇(OCH₃)₁₂. To serve as the electroactive species in an energy storage device, the molecules in various redox states must be highly soluble in organic media and simultaneously stable with respect to chemical decomposition, membrane crossover, and self-discharge. To investigate these properties for the family of POV-alkoxide clusters, we began by examining the electrochemical behaviour of [V^{IV}₄V^{V}₂O₇(OCH₃)₁₂] (1-V₆O₇(OMe)₁₂) in acetonitrile (MeCN). We observed similar redox behaviour for 1-V₆O₇(OMe)₁₂ to that described by Hard and coworkers, based on a cyclic voltammogram (CV) possessing four, one-electron, reversible redox events, with half-wave potentials (E_{1/2}) ranging from 0.72 to +0.85 V vs. Ag/Ag⁺ (FIG. 2, FIG. 1G (Table 1)).

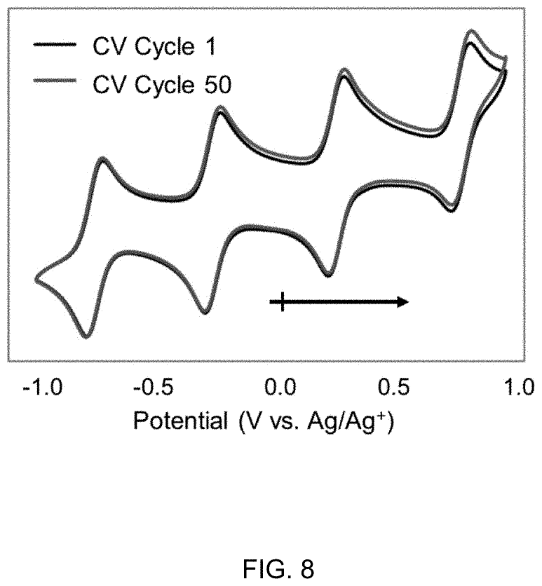

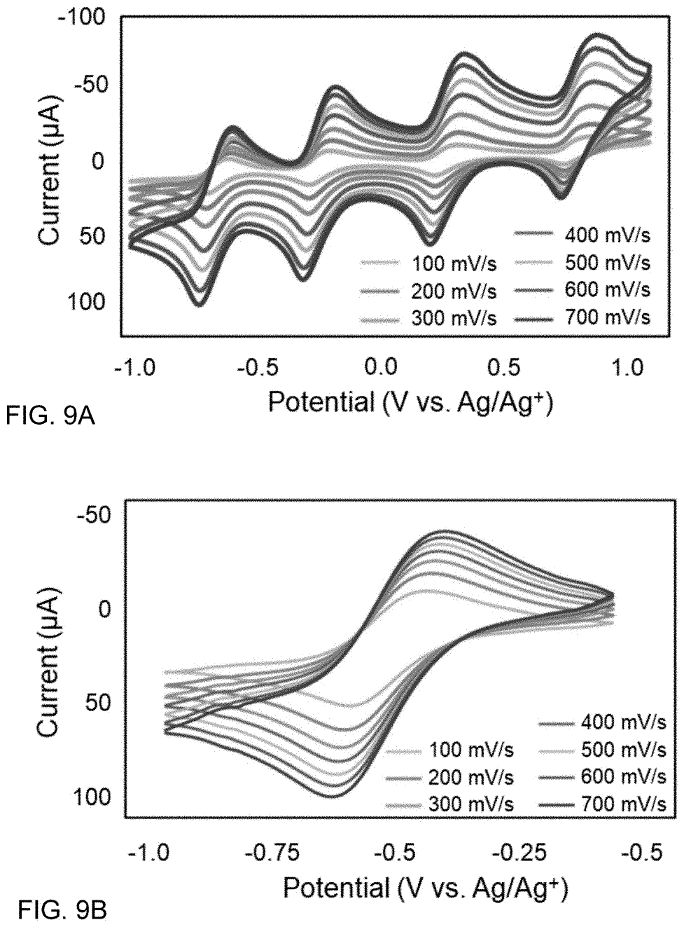

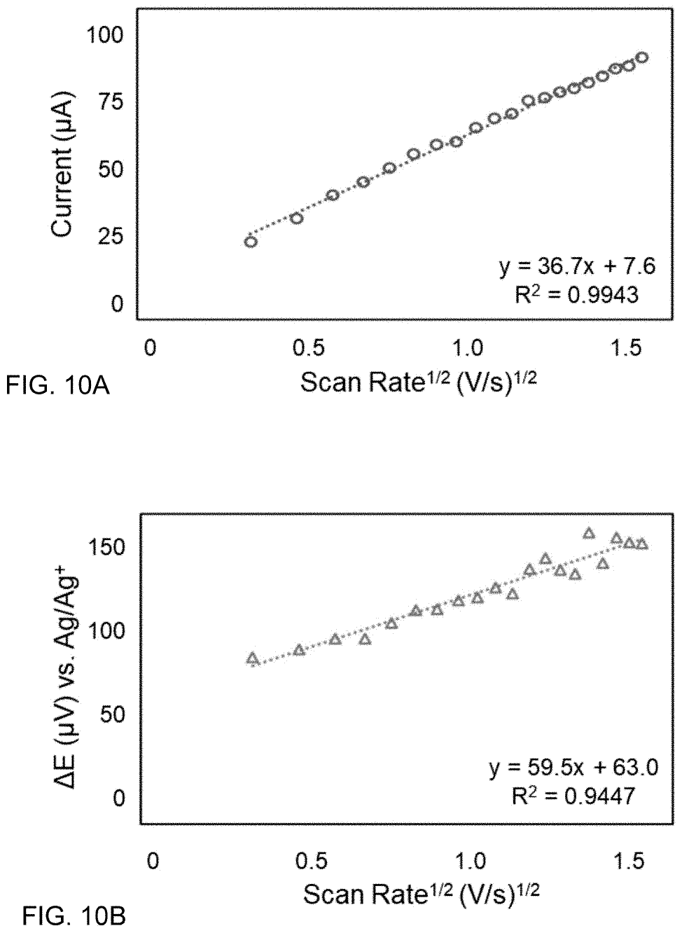

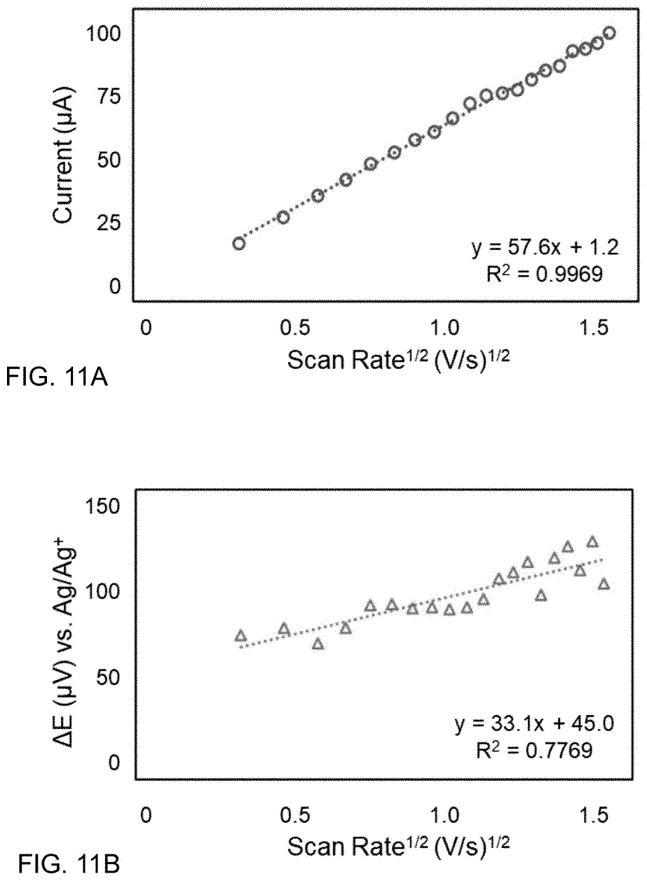

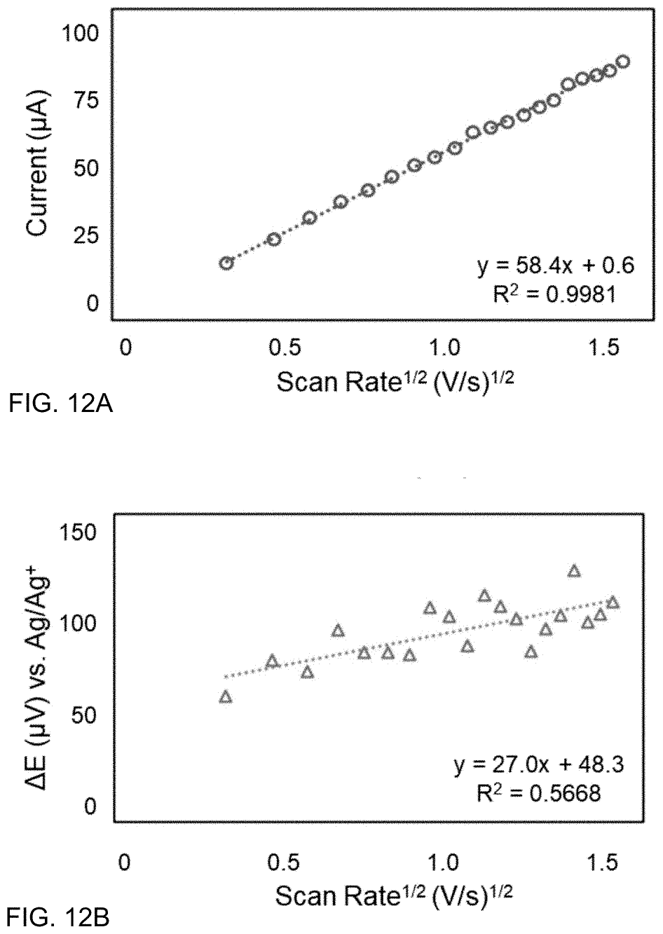

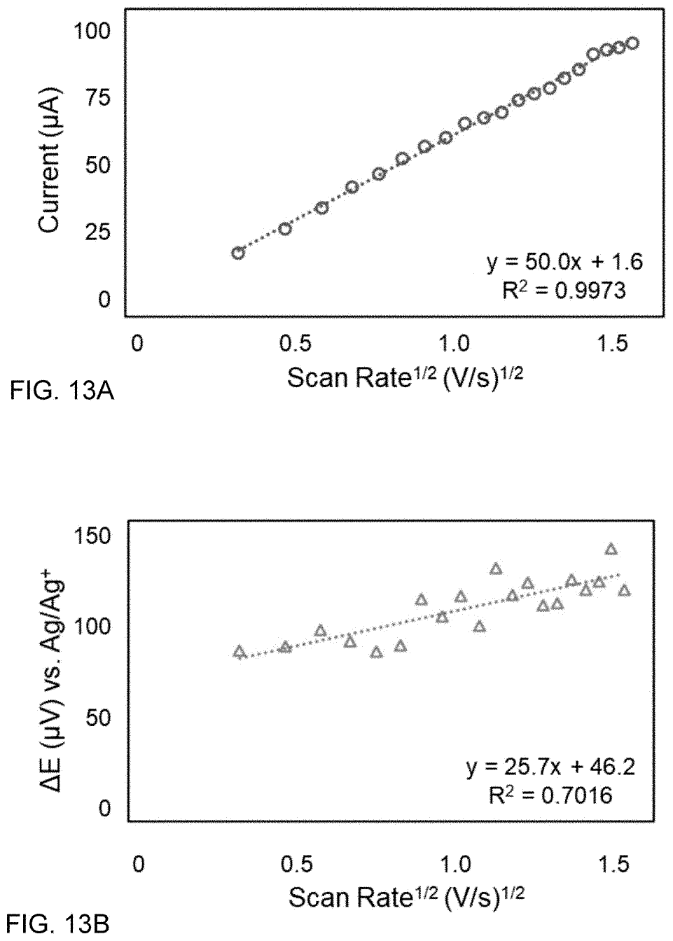

The ability for 1-V₆O₇(OMe)₁₂ to undergo both oxidative and reductive processes enables its use in a symmetric RFB scheme, wherein a single molecule serves as both catholyte and anolyte. [44, 45]. The wide separation between the outermost redox events (ΔE=1.6 V), coupled with the ability of the cluster to hold four electrons, frames this POV-alkoxide as an effective charge carrier for flow batteries, provided that all redox states remain soluble and to obtain a preliminary measure of the electrochemical stability of this system, CV cycling of 1-V₆O₇(OMe)₁₂ was conducted in MeCN. Following fifty cycles (˜1 hour), the CV of 1-V₆O₇(OMe)₁₂ was largely unchanged, indicating good electrochemical stability on the time-scale of a CV experiment (FIG. 8). To further investigate the redox behaviour of 1-V₆O₇(OMe)₁₂, CVs isolating each redox event were obtained at scan rates ranging from 100 to 2000 mV/s (FIG. 9). A linear relationship between the peak currents of each event and the square root of the scan rate was observed, indicating a well-defined, mass-transfer limited process (FIG. 10A, FIG. 10B, FIG. 11A, FIG. 11B, FIG. 12A, FIG. 12B, FIG. 13A, FIG. 13B). [46-47] Thus, the Randles-Sevcik equation could be used to determine the diffusion coefficients for the redox series of POV-alkoxide clusters (FIG. 1G (Table 1)). [48-50] Next, the peak separation, ΔEₚ, was determined for each event, and plotted as a function of the square root of the scan rate (FIG. 10A, FIG. 10B, FIG. 11A, FIG. 11B, FIG. 12A, FIG. 12B, FIG. 13A, FIG. 13B). The increase in ΔEₚ at higher scan rates indicates that each of the four redox events is quasi-reversible. [51] From these data, the Nicholson method was used to determine the heterogeneous electron transfer rate constants for each event (FIG. 1G (Table 1)). [52] These values are relatively fast when compared to previous redox flow battery electrolytes, indicating that galvanostatic charging will not be hindered by sluggish electron transfer. [53, 54]

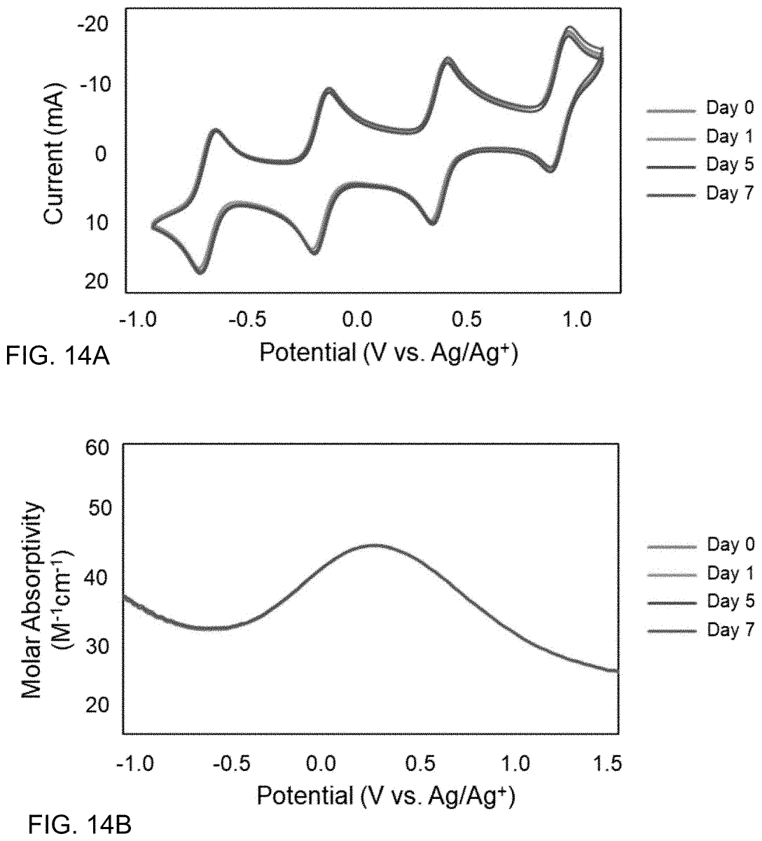

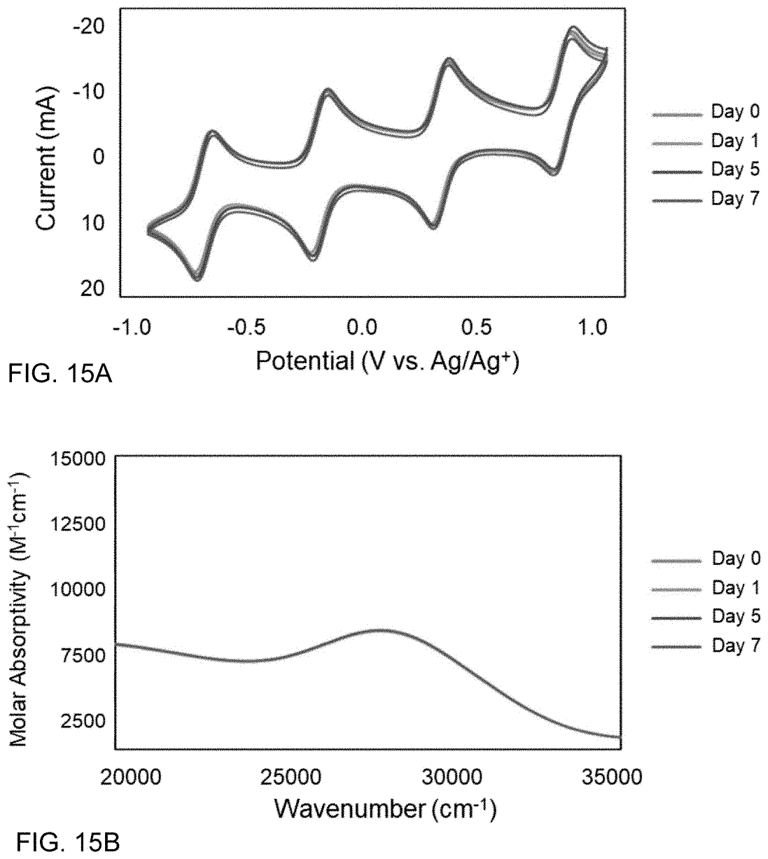

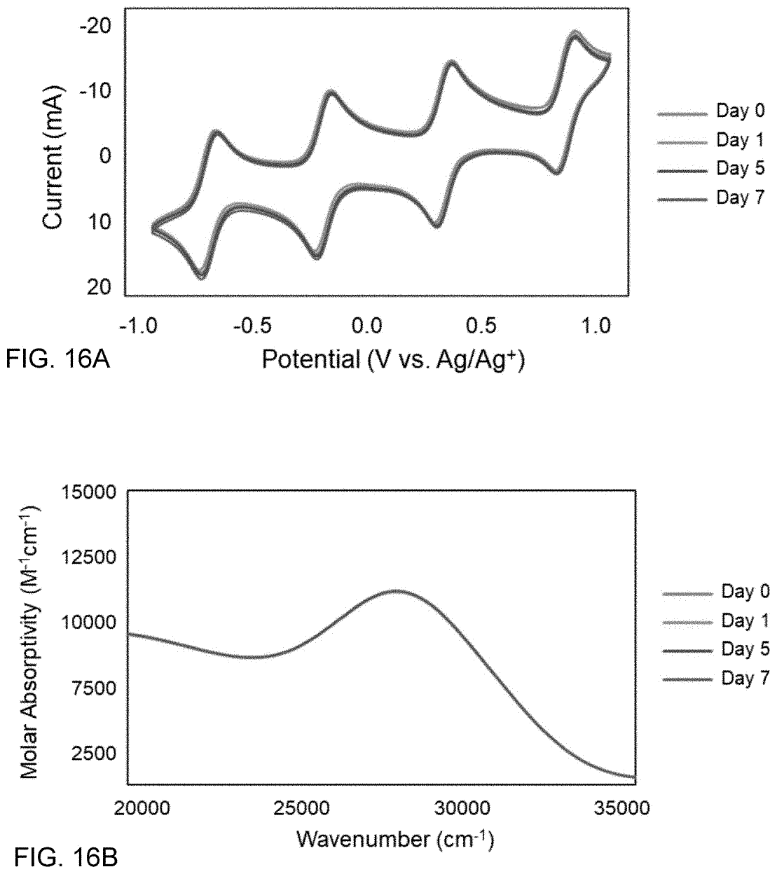

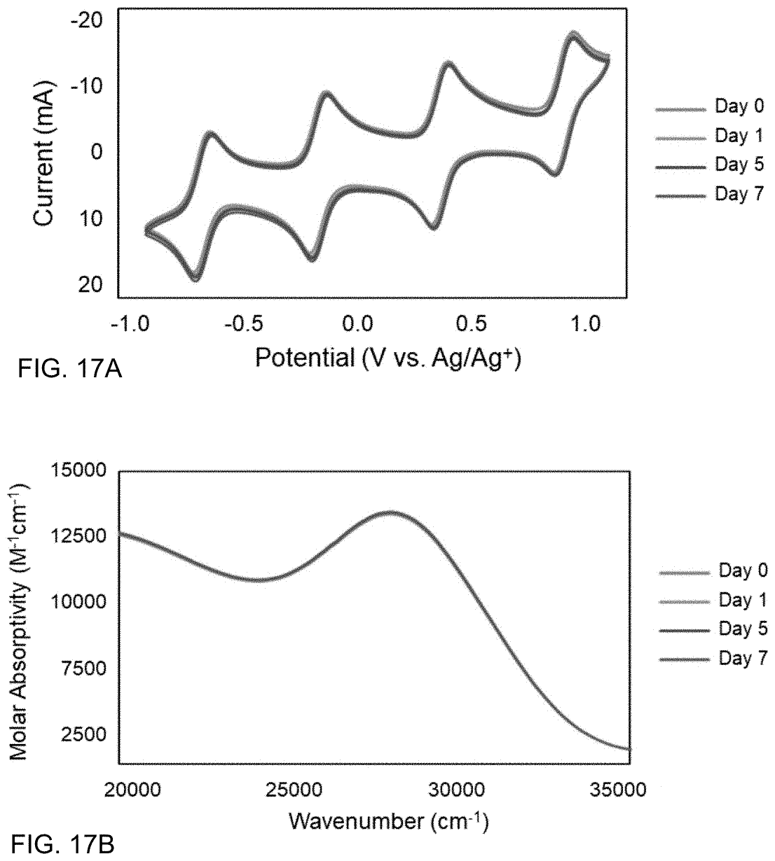

To establish the long-term, solution-phase stability of the various charge-states of complex 1-V₆O₇(OMe)₁₂, the chemical properties of the reduced and oxidized derivatives of the hexavanadate cluster were investigated. An active species should exhibit both electrochemical stability and chemical stability for long electrolyte solution longevity. Electrochemical instability manifests in self-discharge processes, wherein the active species remains intact but undergoes redox reactions that reduce the stored charge. Chemical instability is more damaging in that the active species undergoes a change to its molecular structure, altering its redox behaviour. In an ideal redox flow cell featuring 1-V₆O₇(OMe)₁₂ as the electroactive material, all five oxidation states of the molecule would be accessed throughout the multi-electron charge and discharge cycling. To evaluate the stability of the redox series, the reduced and oxidized derivatives of the hexavanadate cluster, [V^{IV}₆O₇(OCH₃)₁₂]²⁻ (2-V₆O₇(OMe)₁₂²⁻), [V^{IV}₅V^{V}O₇(OCH₃)₁₂]¹⁻ (3-V₆O₇(OMe)₁₂¹⁻), and [V^{IV}₃V^{V}₃O₇(OCH₃)₁₂]¹⁺ (4-V₆O₇(OMe)₁₂¹⁺) were generated via synthetic procedures modelled after literature precedent [43,55] (See also, Part 4). The stabilities of complexes 2-4 in solution after one week were established using electronic absorption spectroscopy and CV (FIG. 14A, FIG. 14B, FIG. 15A, FIG. 15B, FIG. 16A, FIG. 16B, FIG. 17A, FIG. 17B). Little change was noted in the spectra of complexes 2-4, suggesting significant electrochemical and chemical stability for each oxidation state of the POV-alkoxide cluster in solution.

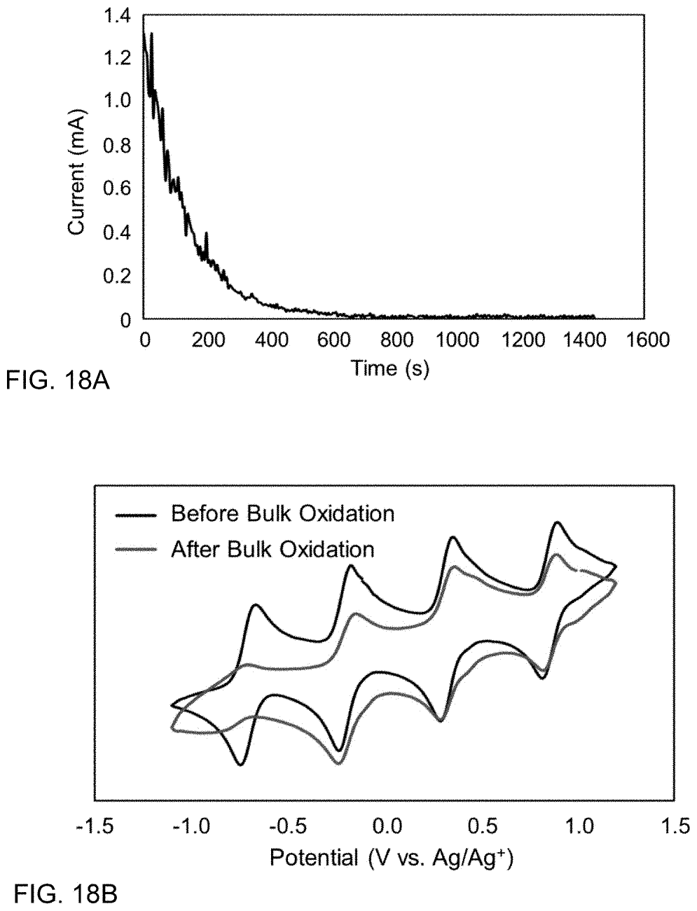

Although four of the five available charge states suggested by the CV of 1-V₆O₇(OMe)₁₂ can be synthetically isolated, attempts to chemically generate the dicationic species, [V^{IV}₂V^{V}₄O₇(OCH₃)₁₂]²⁺ (5-V₅O₆(OMe)₁₂²⁺), were unsuccessful. Given the electrochemical reversibility of this redox event in the CV of 1-V₆O₇(OMe)₁₂, we hypothesized that complex 5-V₅O₆(OMe)₁₂²⁺ could be accessed via electrosynthesis. Bulk oxidation of 1-V₆O₇(OMe)₁₂ at 1.1 V yielded a solution with an open circuit potential of 1.0 V, suggesting successful formation of the desired dicationic charge state (FIG. 18A, FIG. 18B); however, the CV of the resulting solution showed changes in both the potentials and reversibility of all redox waves. Based upon these experiments, we can conclude that complex 1-V₆O₇(OCH₃)₁₂ is not stable under highly oxidizing conditions.

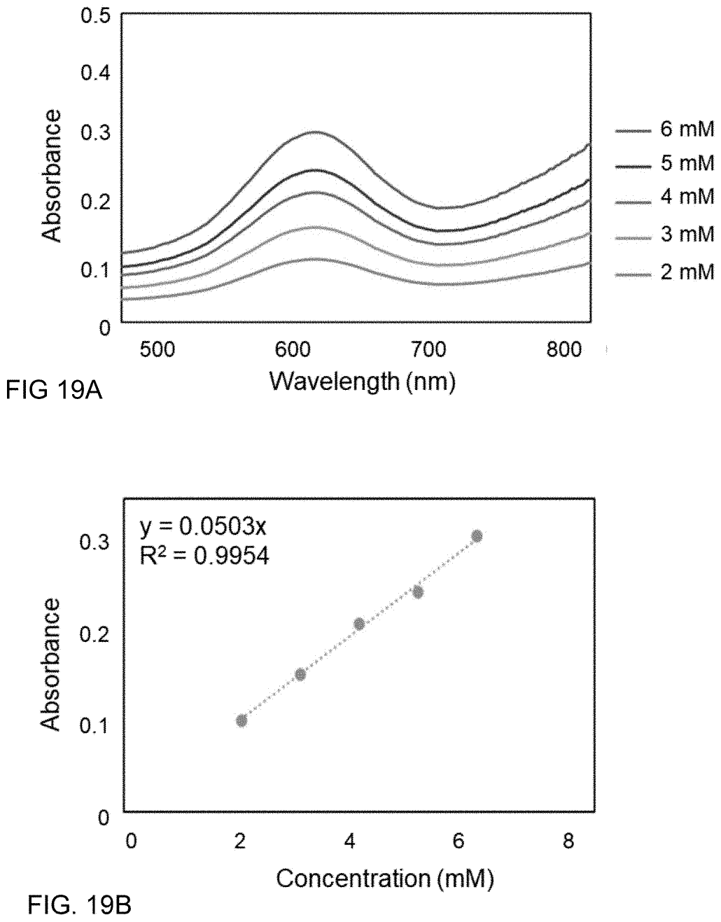

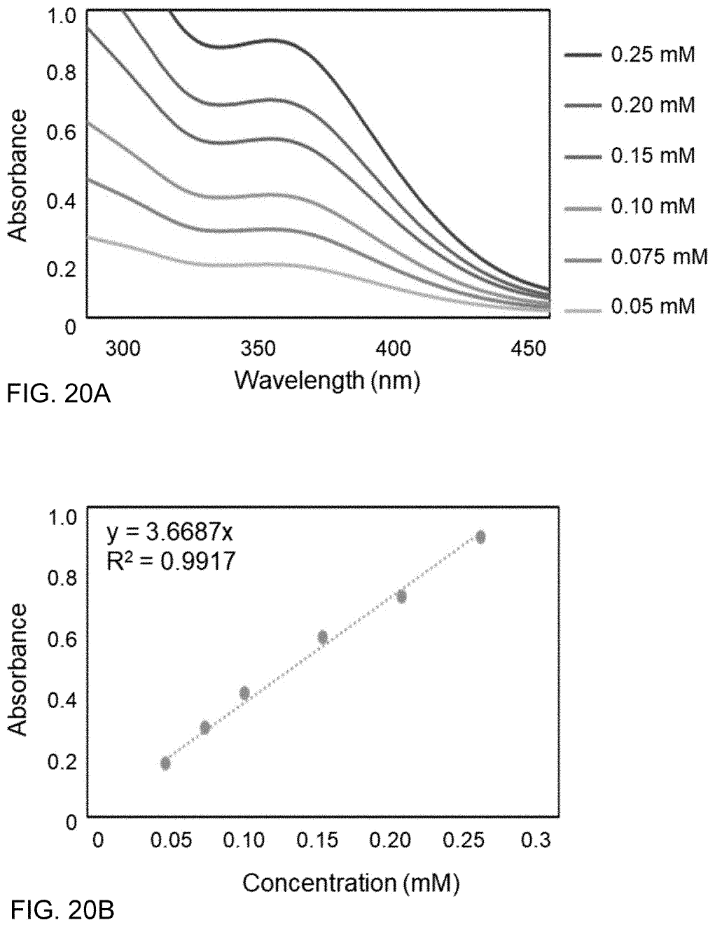

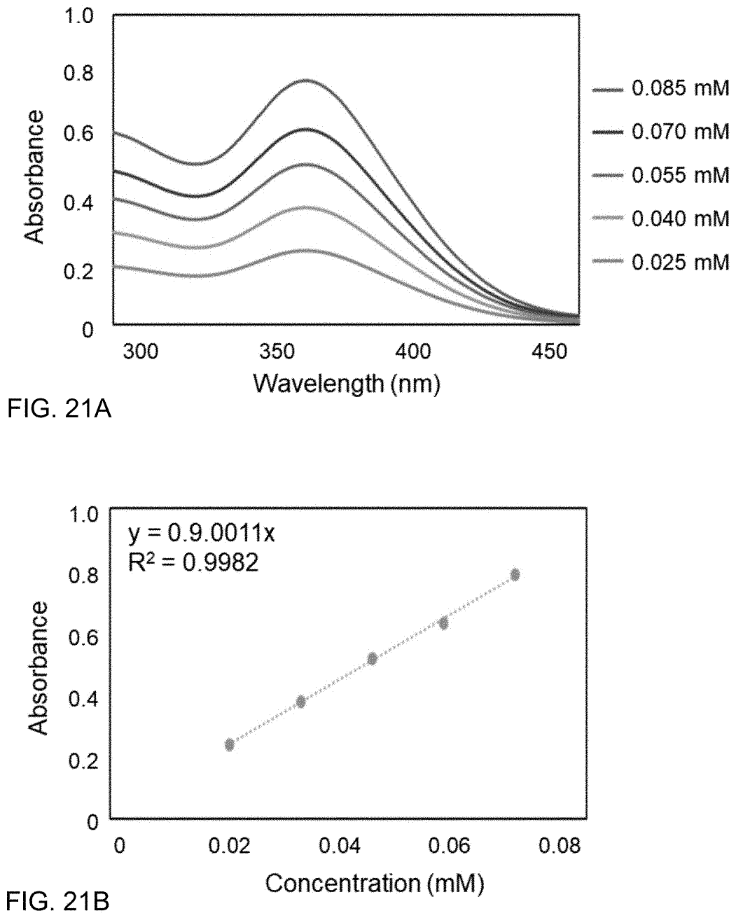

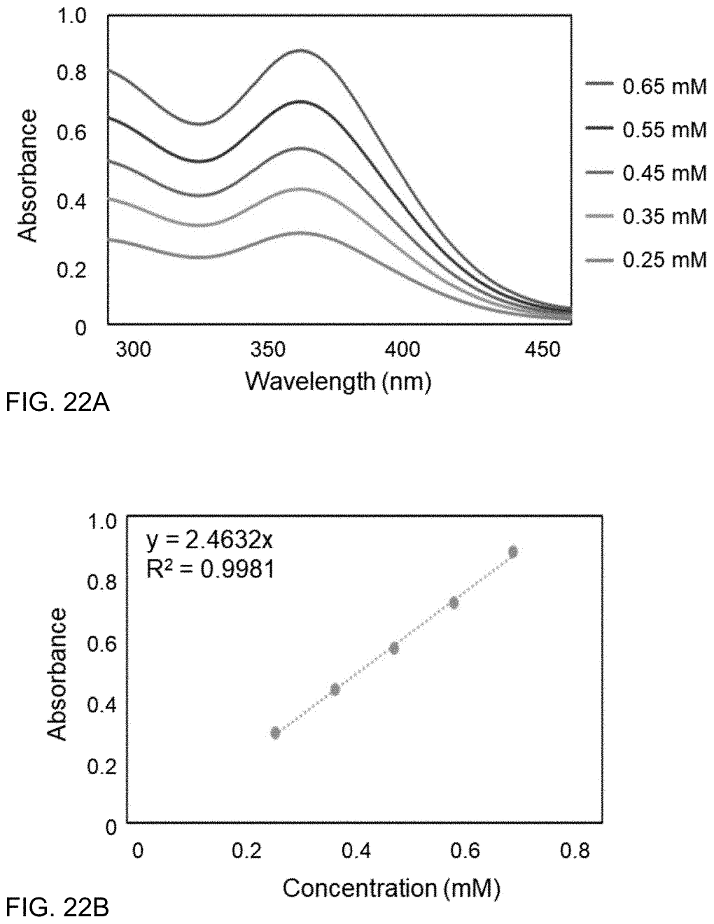

The solubilities of each of the synthetically available redox derivatives of 1-V₆O₇(OMe)₁₂ were determined using electronic absorption spectroscopy in a 0.1 M MeCN solution of tetrabutylammonium hexafluorophosphate ([NBu₄][PF₆]) (FIG. 19A, FIG. 19B, FIG. 20A, FIG. 20B, FIG. 21A, FIG. 21B, FIG. 22A, FIG. 22B). The solubilities for the isolable charged states of the POV-alkoxide cluster (˜100-200 mM) are on the same order of magnitude as previously reported non-aqueous charge carriers. [13, 15, 48-50] The solubility of 1-V₆O₇(OMe)₁₂ distinguishes this cluster from previously explored POM-based electroactive materials, which demonstrate little solubility or stability in organic media. [33-35] We credit this enhanced solubility to the bridging alkoxide ligands in 1-V₆O₇(OMe)₁₂, which serve to stabilize the low charge-state of this cluster as well as to cooperatively interact with the polar organic solvent, MeCN. The collective physical and electrochemical properties of 1-V₆O₇(OMe)₁₂ motivate continued electrochemical analyses of the polynuclear charge carrier.

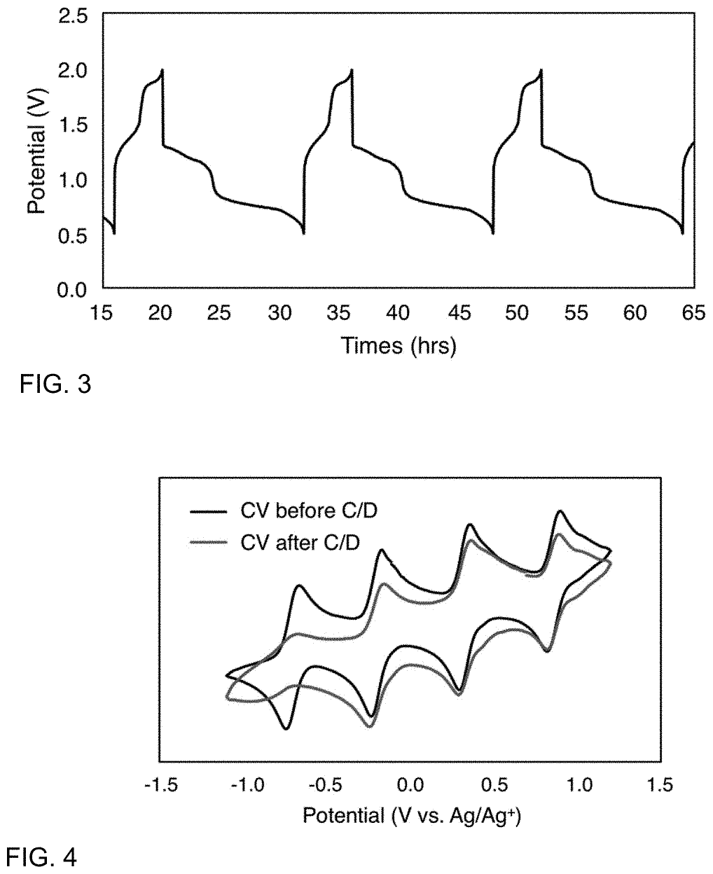

Extended Cycling of [V₆O₇(OMe)₁₂]. To evaluate the potential for 1-V₆O₇(OMe)₁₂ to serve as the electroactive species in a NRFB, charge-discharge experiments were conducted in a static H-cell divided by an anion exchange membrane (AMI-7001) (FIG. 3). Prior to charging, each half of the H-cell contained 15 mL of a solution of 0.01 M 1-V₆O₇(OMe)₁₂ with 0.5 M [NBu₄][PF₆] supporting electrolyte. Galvanostatic charging conditions were used, with a cut-off potential of 2.0 V, so as to include all four redox couples. A charging current of 0.2 mA and discharging current of 0.02 mA were selected based on preliminary experiments, with the lower discharge current intended to reduce overpotentials and ensure a complete discharge. FIG. 3 shows the trace of cycles 2-4 obtained from this experiment. The coulombic efficiency was ˜97% during cycling, with a state-of-charge for each cycle of ˜28%. Two plateaus are observed in both the charging and discharging traces, indicative of two separate electron transfer events. The charging plateaus at 1.4 V and 1.8 V fall to 0.8 V and 1.3 V, respectively, upon discharge of the cell, giving an average potential drop of ˜0.5 V. Potential losses during discharge in related systems have been attributed to mass-transport limitations and high internal resistance associated with cell design, which are similarly operative here. [56, 57]

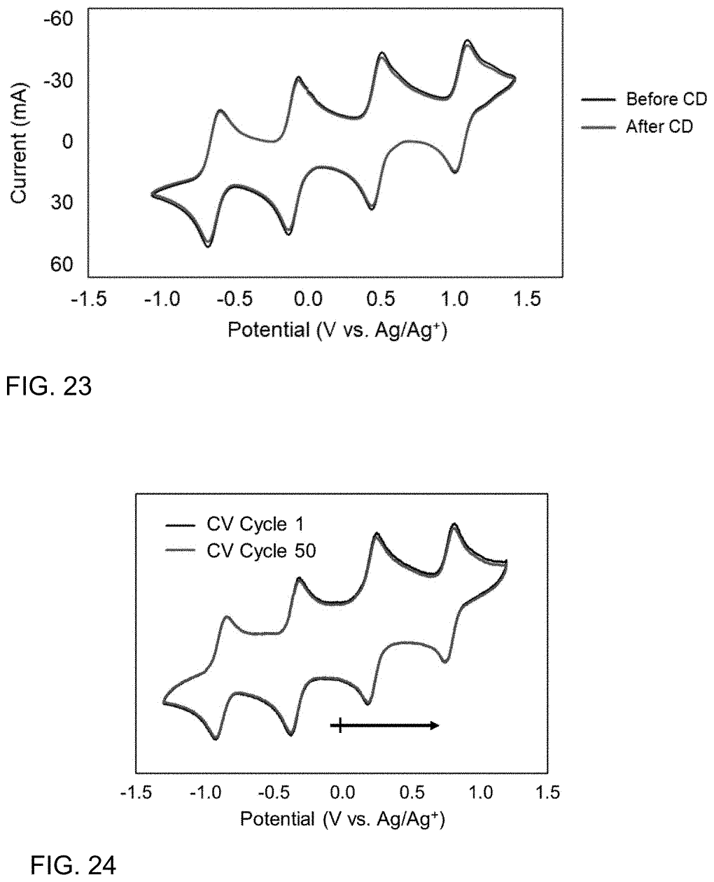

To investigate the stability of the electroactive species, 1-V₆O₇(OMe)₁₂, during charge-discharge experiments, CVs of the anolyte and catholyte solutions were obtained following cycling. Although the catholyte solution showed no change based on its CV (FIG. 23), the anolyte solution revealed potential shifts and loss of reversibility analogous to those observed following bulk oxidation of 1-V₆O₇(OMe)₁₂ at +1.1 V (FIG. 4). This result is consistent with the previously discussed oxidative instability of complex 1-V₆O₇(OMe)₁₂ under NRFB charging-schemes, limiting the effectiveness of the metal-oxide scaffold as an energy-dense charge-carrier.

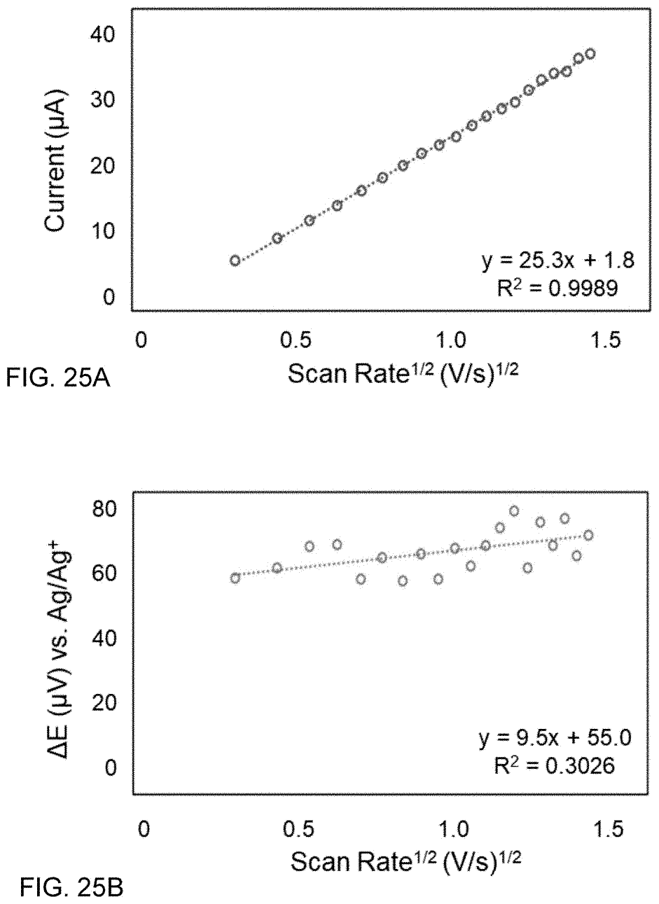

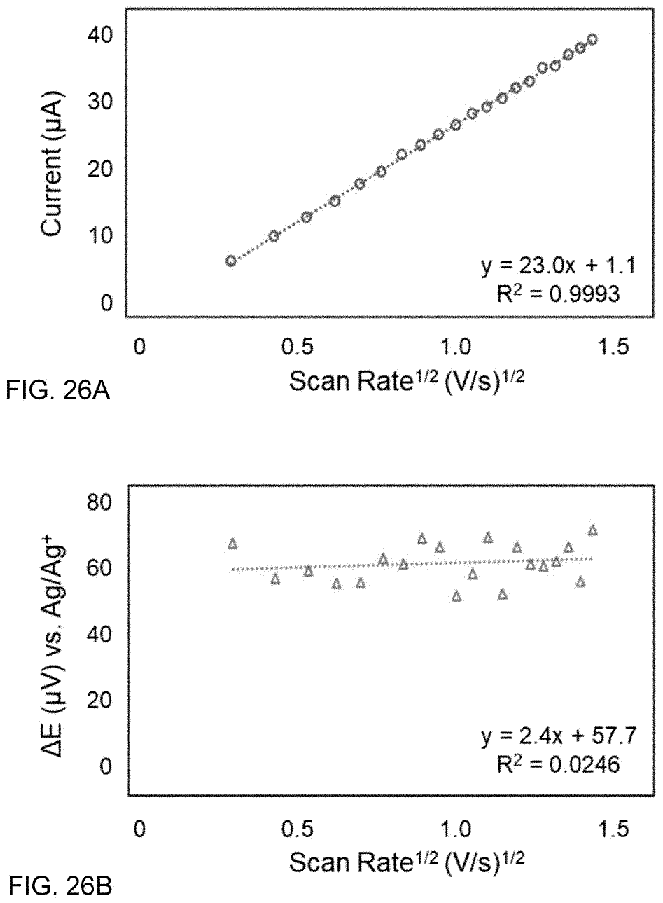

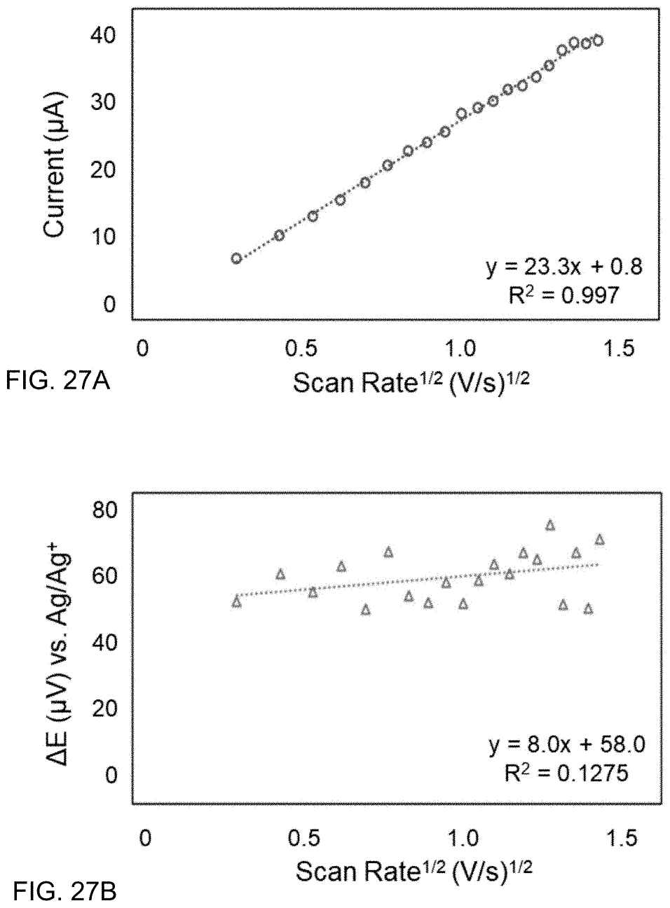

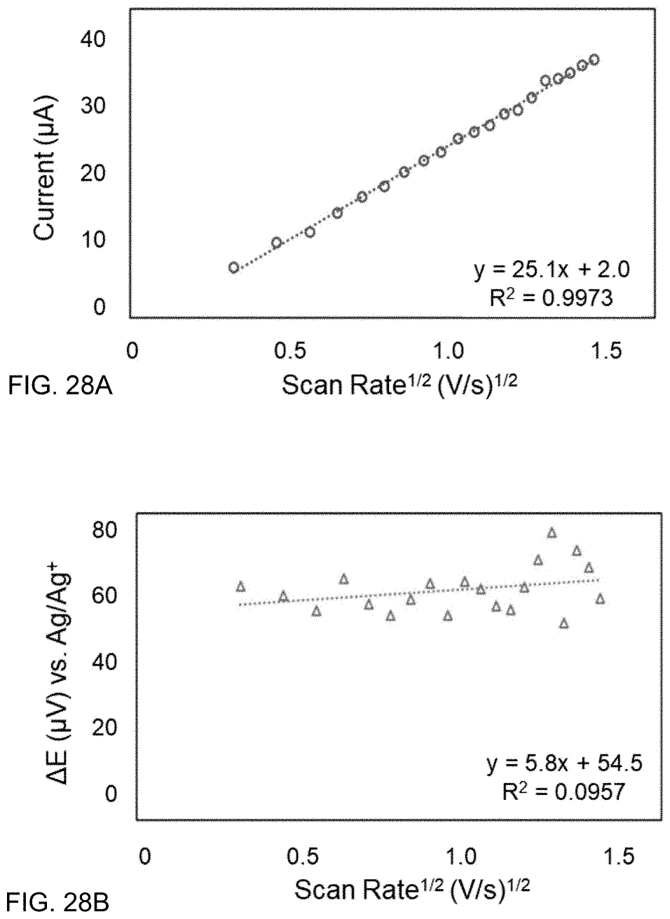

Electrochemical Optimization via Ligand Substitution. Given the oxidative instability of complex 1-V₆O₇(OMe)₁₂ (vide supra) we hypothesized that the incorporation of bridging alkoxide ligands with a larger positive inductive effect would prevent active species degradation during cell cycling. The ethoxide-functionalized variant of the mixed-valent polyoxovanadate cluster, [V^{IV}₄V^{V}₂O₇(OC₂H₅)₁₂] (6-V₆O₇(OEt)₁₂) has been reported, [42, 4] with redox potentials of the four quasi-reversible events shifted ˜−0.12 V from that of 1-V₆O₇(OMe)₁₂ (FIG. 2, FIG. 1G (Table 1)). The slight cathodic shift of the single electron redox events demonstrates the inductive effect that occurs as a consequence of ligand modification. The CV of complex 6-V₆O₇(OEt)₁₂ shows good reversibility over 50 cycles (FIG. 24), and diffusion coefficients, with heterogeneous electron transfer rate constants similar to those determined for 1-V₆O₇(OMe)₁₂ (FIG. 1G (Table 1), FIG. 25A, FIG. 25B, FIG. 26A, FIG. 26B, FIG. 27A, FIG. 27B, FIG. 28A, FIG. 28B). Collectively, these data suggest that this cluster exhibits good short-term electrochemical stability and kinetics, warranting further investigation of its function as a charge carrier for NRFBs.

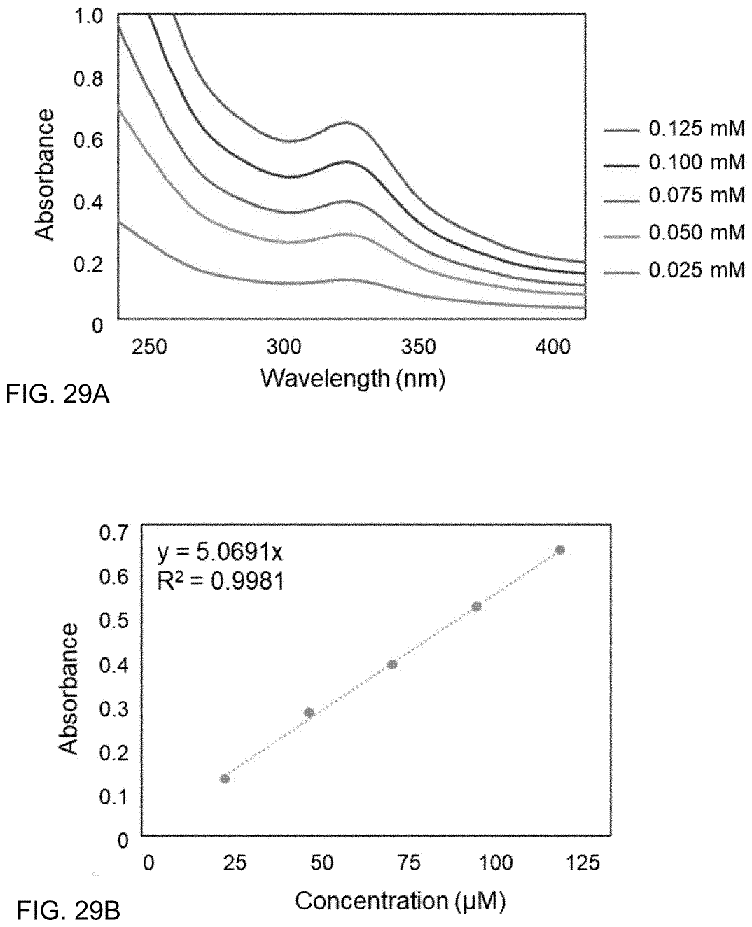

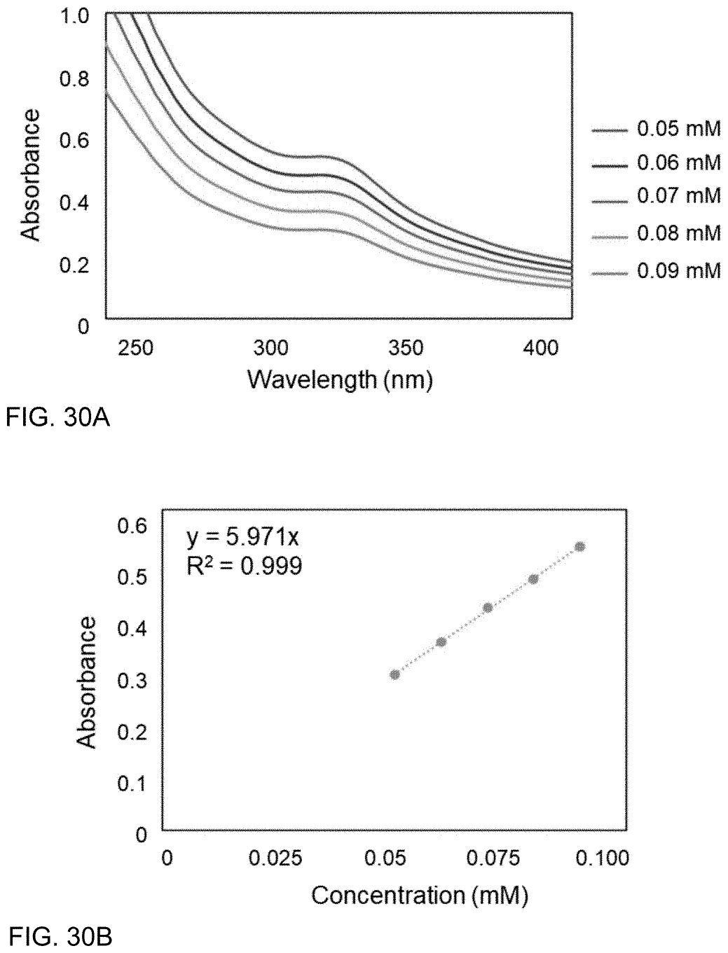

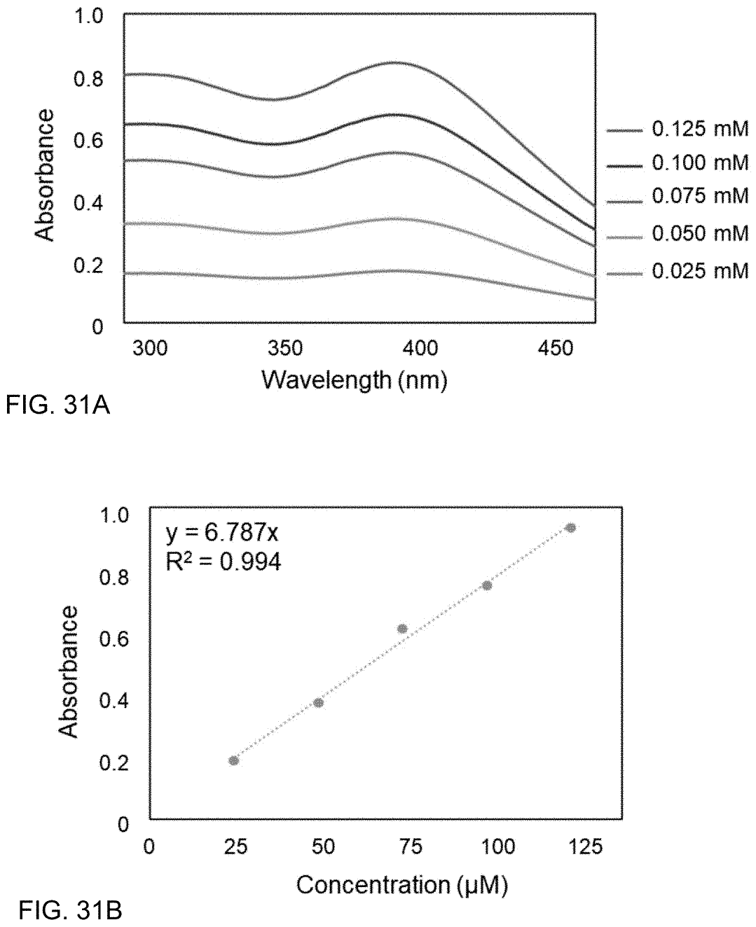

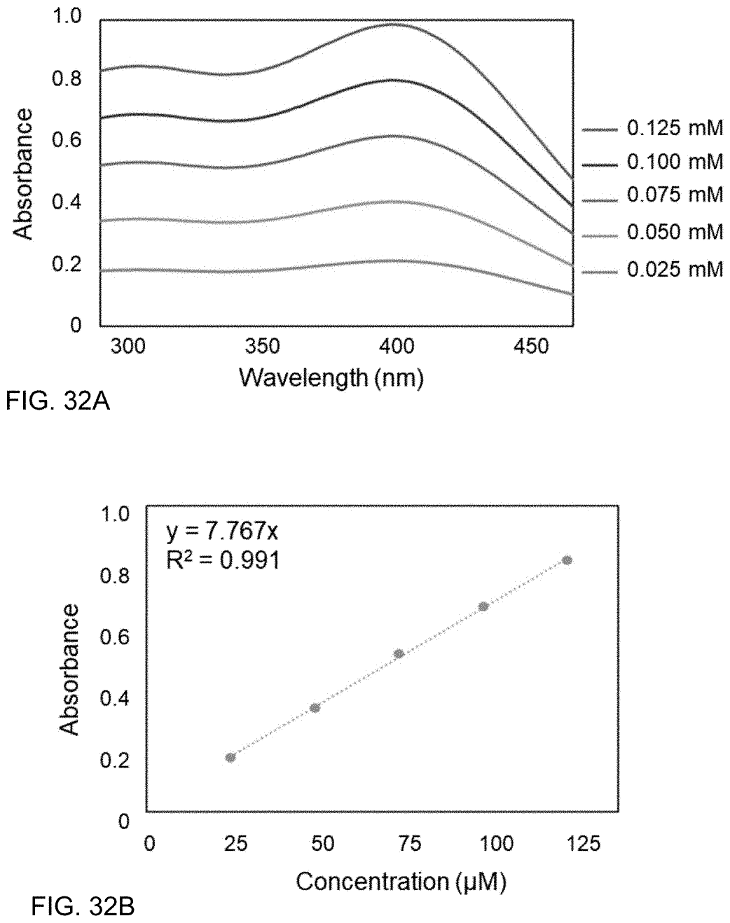

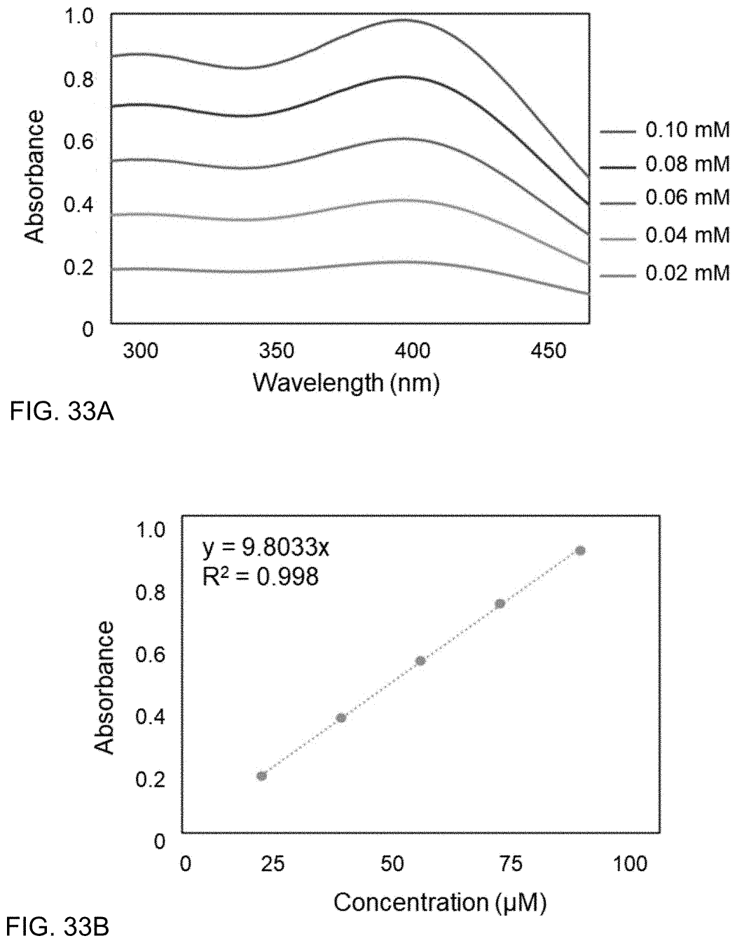

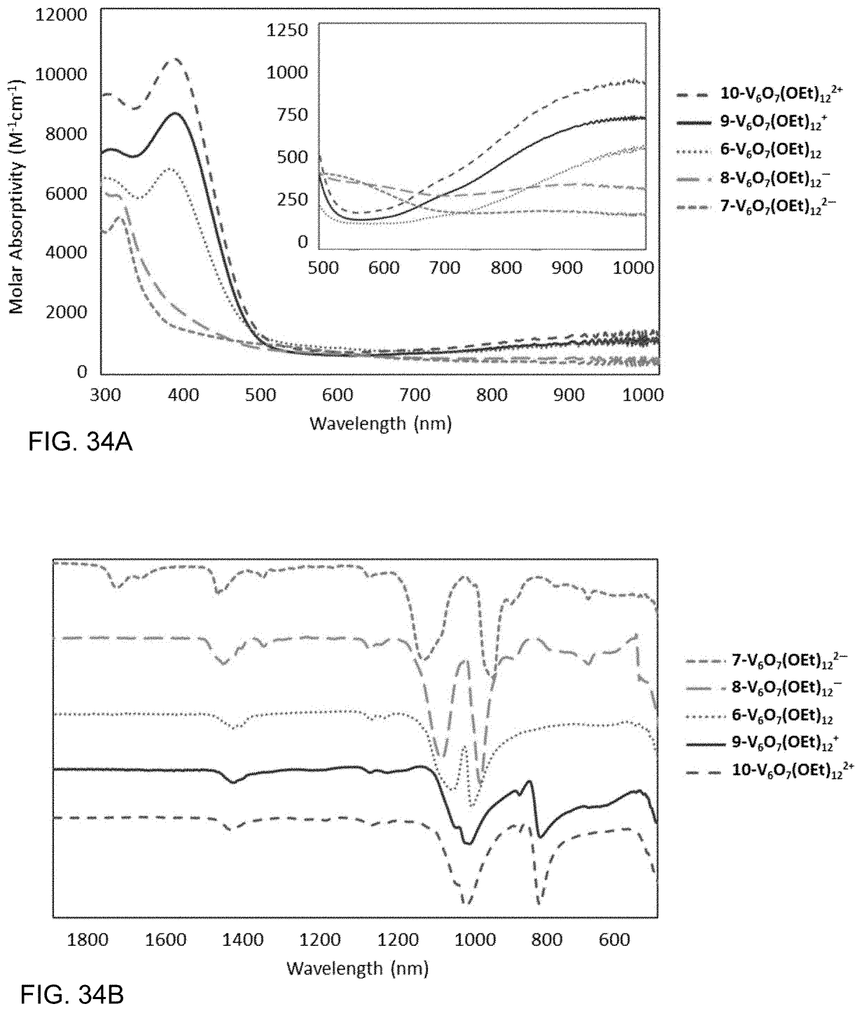

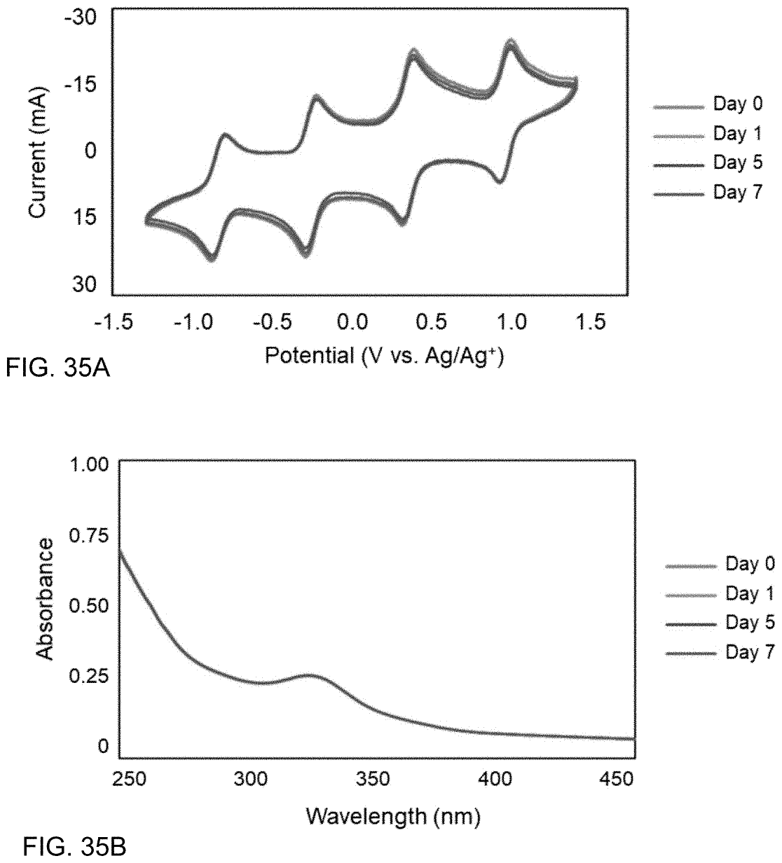

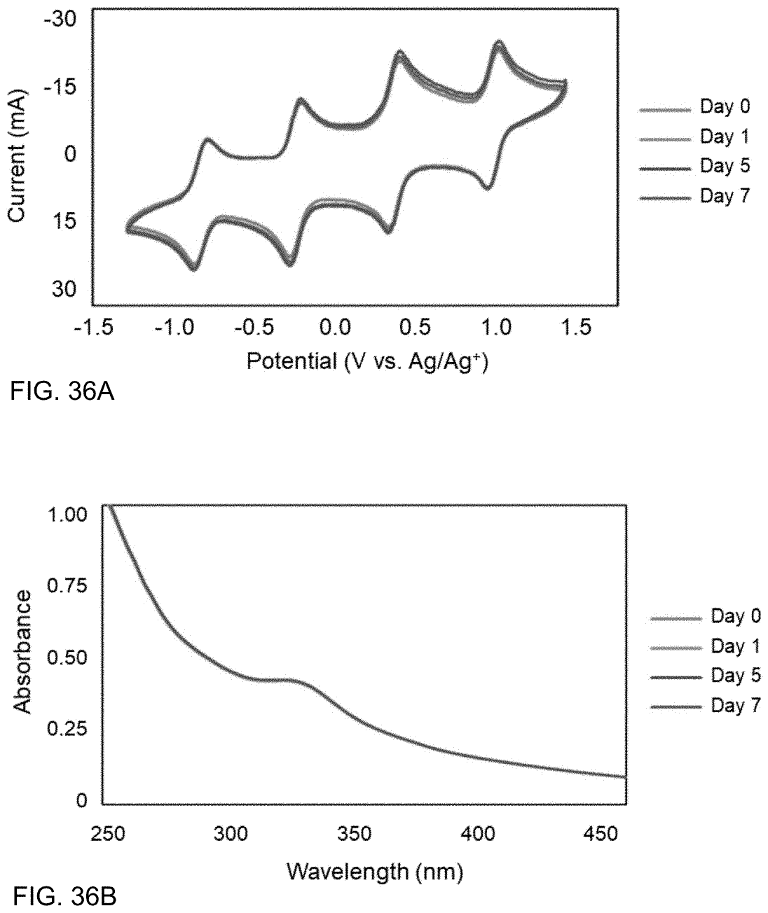

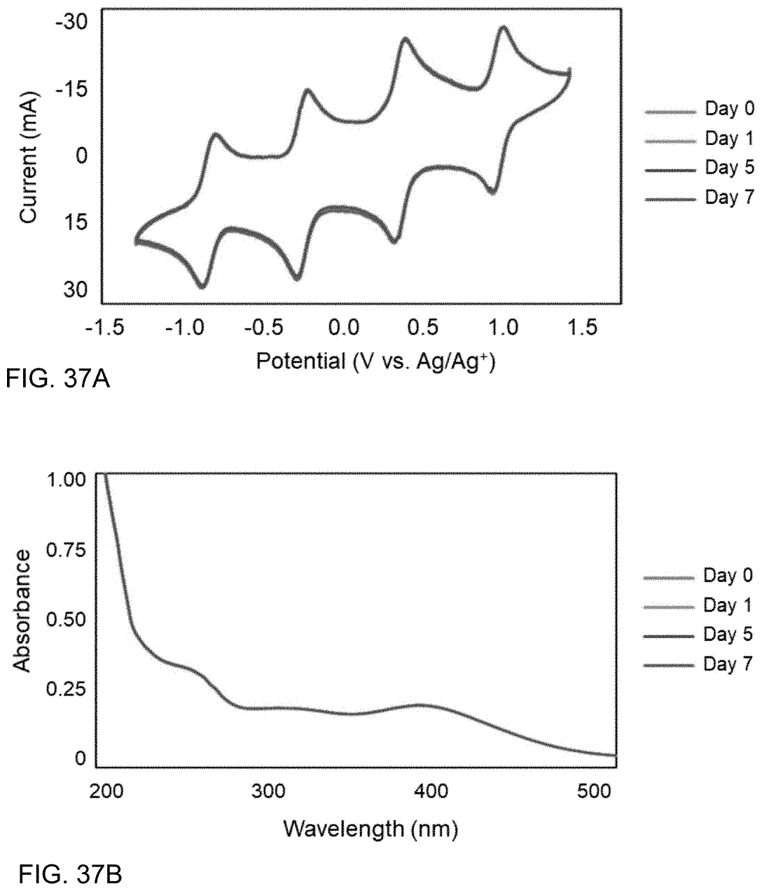

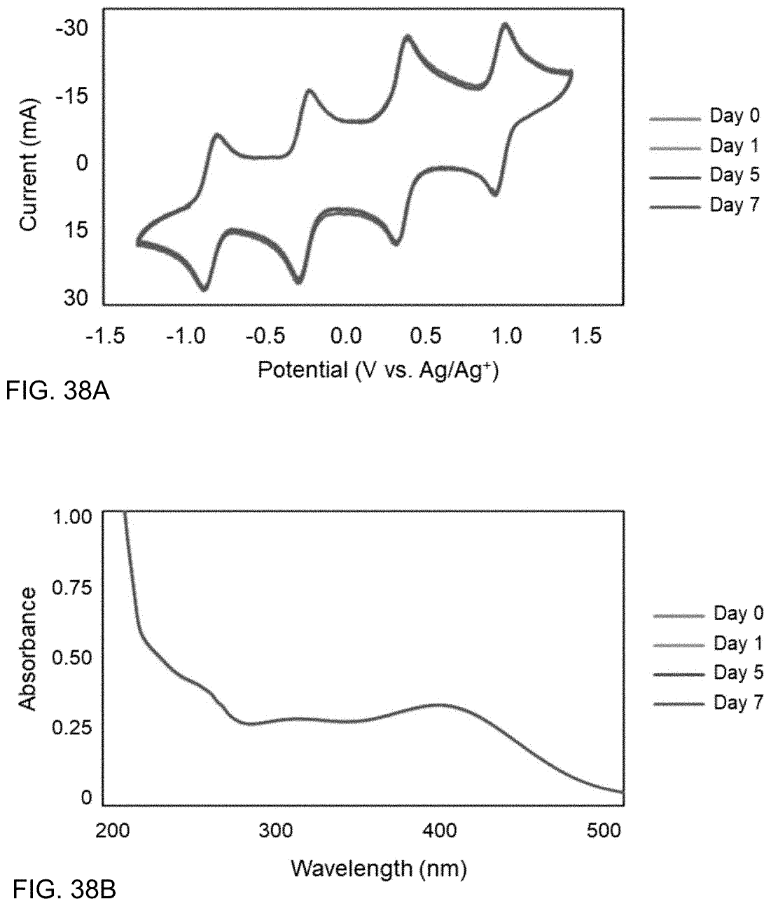

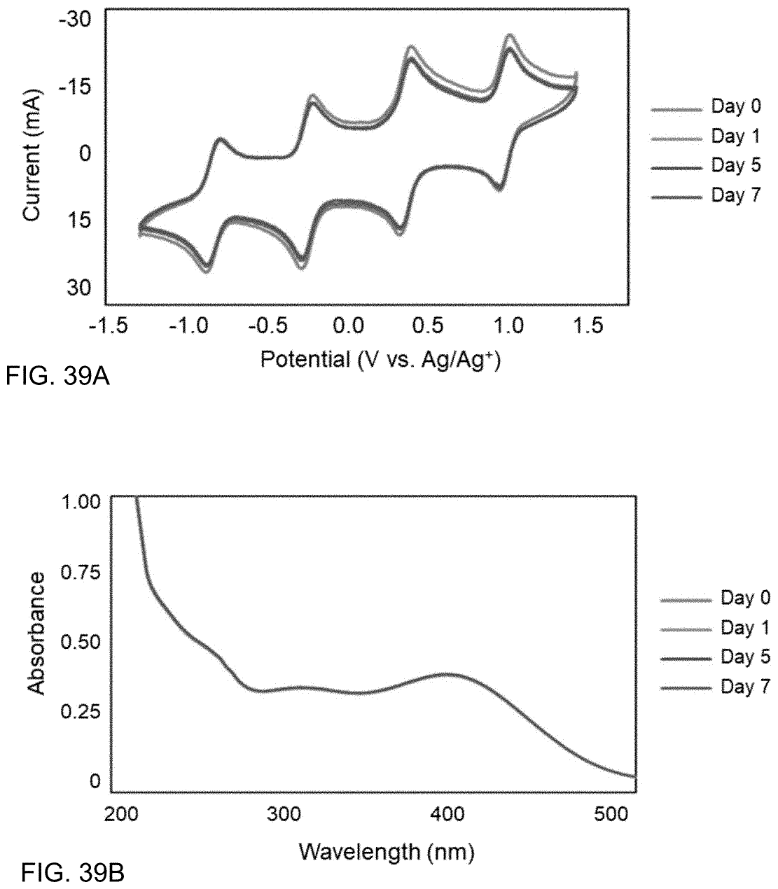

As such, we set out to verify the physical and electrochemical properties of complex 6-V₆O₇(OEt)₁₂. The syntheses of the five redox states of the ethoxide-functionalized cluster, namely [V^{V}₆O₇(OC₂H₅)₁₂]²⁻ (7-V₆O₇(OEt)₁₂²⁻), [V^{IV}₅V_{V}O₇(OC₂H₅)₁₂]¹⁻ (8-V₆O₇(OEt)₁₂¹⁻), [V^{IV}₃V^{V}₃O₇(OC₂H₅)₁₂]¹⁺ (9-V₆O₇(OEt)₁₂¹⁺), and [V^{IV}₂V^{V}₄O₆(OC₂H₅)₁₂]¹⁻ (10-V₆O₇(OEt)₁₂²⁻), were performed to verify their solubility and solution stability at longer time scales (FIG. 29A, FIG. 29B, FIG. 30A, FIG. 30B, FIG. 31A, FIG. 31B, FIG. 32A, FIG. 32B, FIG. 33A, FIG. 33B). As the isolation of complexes 7-V₆O₇(OEt)₁₂²⁻ and 8-V₆O₇(OEt)₁₂¹⁻ had not been reported previously, we independently synthesized these molecules via stoichiometric chemical reduction (See also, Part 4). Characterization of the family of POV-alkoxide clusters (complexes 6-10) via infrared and electronic absorption spectroscopies revealed the expected trends for sequential oxidation of the hexavanadate core, confirming isolation of each member of the redox series (FIG. 34A, FIG. 34B). Over the course of one week, complexes 6-10 showed no evidence of degradation based on CV and electronic absorption spectroscopy (FIG. 35A, FIG. 35B, FIG. 36A, FIG. 36B, FIG. 37A, FIG. 37B, FIG. 38A, FIG. 38B, FIG. 39A, FIG. 39B). Results from these stability investigations suggest that, like its methoxide congener, the ethoxide-functionalized polyoxovanadate cluster has sufficient stability to serve as a charge carrier for NRFBs.

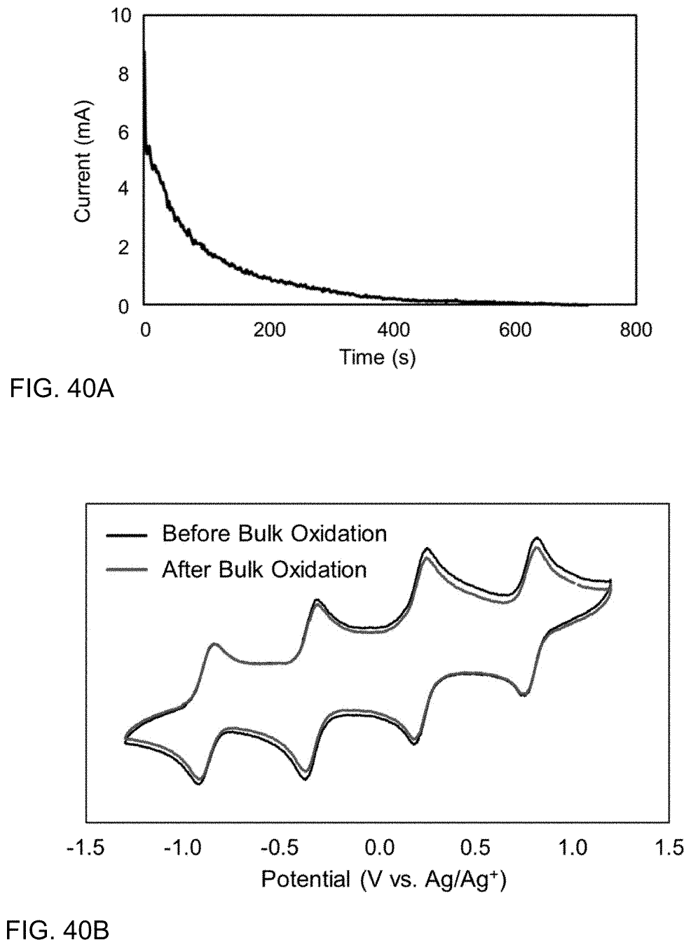

A deficiency in complex 1-V₆O₇(OMe)₁₂ is the oxidative instability of the cluster core, rendering the system incapable of storing multiple electrons per charge carrier. In contrast to complex 1-V₆O₇(OMe)₁₂, Hartl and coworkers have presented the isolation of the mono- and di-cationic derivatives of the ethoxide-functionalized cluster, demonstrating the enhanced stability of this system under highly oxidizing conditions. [43] To confirm the stability of the most-oxidized cluster under conditions relevant to cell cycling, bulk electrolysis was performed on a 0.01 M sample of 6-V₆O₇(OEt)₁₂. Following oxidation at +1.1 V, a CV of the resulting solution was identical to that of the neutral cluster, apart from its open circuit potential, which shifted to 1.0 V vs. Ag/Ag⁺ (FIG. 40A, FIG. 40B). This result suggests quantitative conversion to the desired oxidized species, 10-V₆O₇(OEt)₁₂²⁺, consistent with improvements to the stability of the hexavanadate, Lindqvist core following ligand substitution.

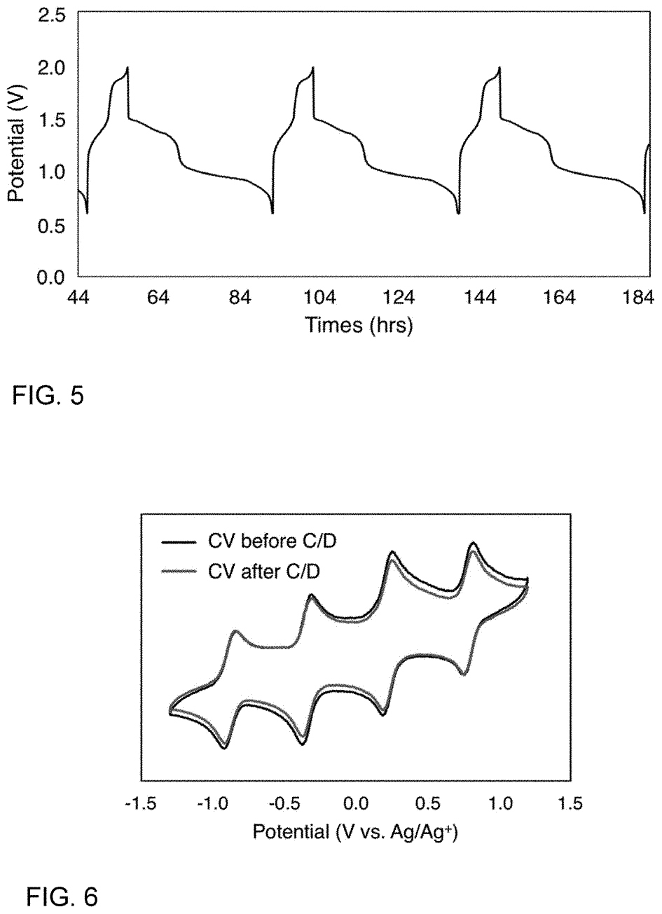

To continue our assessment of 6-V₆O₇(OEt)₁₂, we conducted charge-discharge cycling experiments using identical parameters to those selected for the previous cycling experiment with 1-V₆O₇(OMe)₁₂. FIG. 5 shows the trace for cycles 2-4 of this experiment, with plateaus that indicate a two-electron transfer occurs during both charging and discharging of the cell. The coulombic efficiency was ˜97% over the course of cycling, with a state-of-charge of ˜23%. A potential drop of ˜0.3 V was observed upon discharging the cell, indicating that overpotential losses were decreased by ˜0.2 V when 6-V₆O₇(OEt)₁₂ was used in place of 1-V₆O₇(OMe)₁₂. This enhanced performance may be due to a better membrane compatibility for the larger cluster, resulting in a lower internal resistance, as discussed further below.

To monitor the stability of 6-V₆O₇(OEt)₁₂ during cycling, CVs of the electrolyte solutions were obtained before and after the experiment (FIG. 6). Following the charge-discharge experiment, we observe that the CV of both the catholyte and anolyte solutions remains unchanged. This result is in stark contrast with the CV of complex 1-V₆O₇(OMe)₁₂ following charge-discharge experiments. This electrochemical data confirms that there is no decomposition of the active species throughout cycling for 6-V₆O₇(OEt)₁₂.

The charge-discharge cycles and electrochemical profiles of complexes 1-V₆O₇(OMe)₁₂ and 6-V₆O₇(OEt)₁₂ demonstrate the first example of multielectron storage with metal-oxide clusters for NRFBs. Only one prior system has been reported for the application of POM clusters as charge-carriers in organic solvents. In recent work, Barteau and coworkers have summarized the successful implementation of a Keggin-type cluster, Li₃[PMo₁₂O₄₀] as an electroactive material in MeCN (FIG. 1D). [35] Like the POV-alkoxide complexes reported here, the cluster exhibits remarkable stability and coulombic efficiency (97%) under charge-cycling conditions. However, due to the lack of bridging alkoxide ligands, Li₃[PMo₁₂O₄₀] possesses modest solubility in acetonitrile (˜0.01 M), as compared to the POV-alkoxide clusters. Furthermore, the POM has a narrow potential window (V_{cell}=0.36 V) and is capable of cycling only one electron, limiting the impact of this entry for non-aqueous flow battery charge carrier development. By comparison, the POV-alkoxide clusters possess V_{cell} values of ˜1.7 V, rivalling the electrochemical parameters of recently reported metal coordination complexes. [13] The wide electrochemical window of this family of cluster compounds affords an opportunity to take advantage of the enhanced electrochemical stability of MeCN.

Furthermore, whereas ligand-based modifications have primarily been used to enhance charge carrier solubility, [12,14] we have now demonstrated that simple substitutions of bridging alkoxide moieties (i.e. ethoxide for methoxide) can have a profound effect on the stability of a polynuclear, electroactive material. In the case of mononuclear metal coordination complexes, such ligand-based stabilizations require an entire redesign of the scaffold, often resulting in new coordination environments for the metal centre. [8] In contrast, we have established that the stability of POV-alkoxide clusters may be controlled through facile alkoxide substitution, preserving the multi-electron redox activity of the hexavanadate core. This unique example of multielectron storage across a readily modified metal-oxide scaffold clearly demonstrates the potential of alkoxide-bridged POMs to serve as superior charge-carriers for emerging NRFB technologies.

Crossover and Membrane Fouling. A difficulty facing all flow cell-based energy storage devices is the selection of membrane separators that are compatible with the electrolyte solutions. [58, 59] Two deleterious processes that can occur between charge-carrier and membrane are membrane crossover and membrane fouling. [60] In cells where the anolyte and catholyte solutions contain two different redox-active species, membrane crossover results in cross-contamination that affects coulombic efficiency and leads to long-term fouling of the electrolyte solutions. This destructive property of asymmetric redox flow batteries can be obviated through the design of symmetric flow cells. In these systems, the same electroactive molecule functions at both the cathode and anode. That said, crossover within a symmetric cell still results in a decrease of the coulombic efficiency via deleterious charge-state recombination, even though the lifetimes of the electrolyte solutions are not affected.

In addition to the widely spaced redox events that allow POV-alkoxide clusters to serve as the active species for symmetric NRFB cells, these hexavanadate structures also benefit from an exceptionally large size relative to organic molecules and coordination complexes (˜9.3 Å and ˜12.0 Å in diameter for 1-V₆O₇(OMe)₁₂ and 6-V₆O₇(OEt)₁₂ respectively). [43] We noted that during charge-discharge experiments with 1-V₆O₇(OMe)₁₂, cluster degradation was only observed in the anolyte solution, while the catholyte solution remained unaffected by charge cycling (FIG. 4, FIG. 23). Had there been significant crossover between these two half-cells, we would expect that the CV of both halves would be identical. This initial observation suggests the large size of the hexavanadate cluster prevents membrane crossover.

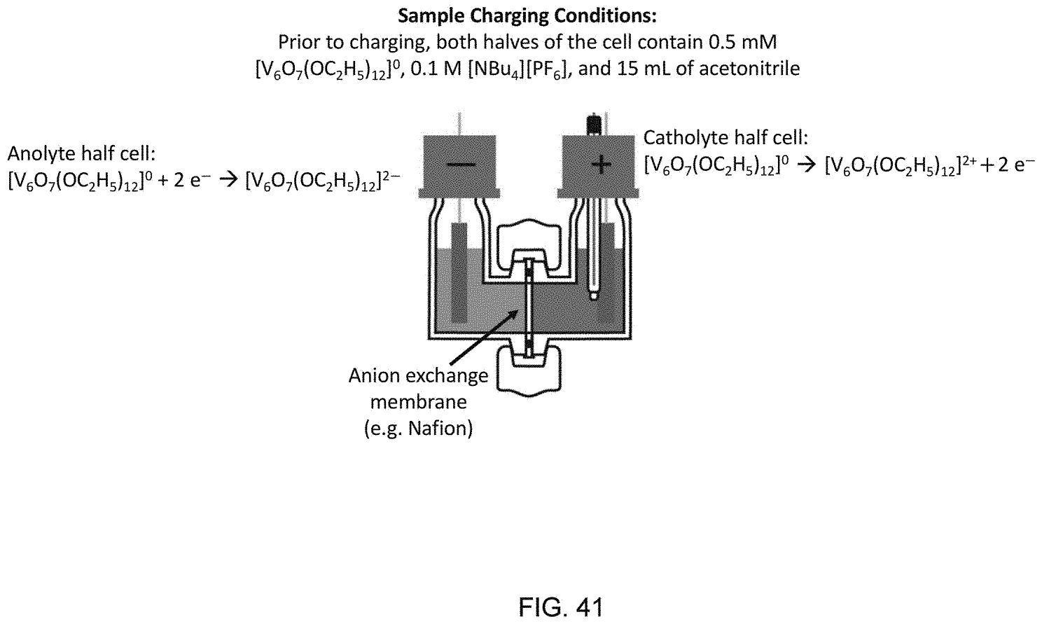

To further test this hypothesis, absorption spectroscopy experiments were performed to measure the extent of crossover of 1-V₆O₇(OMe)₁₂ and 6-V₆O₇(OEt)₁₂ through the H-cell membrane. FIG. 41 shows an exemplary H-cell with sample charging conditions.

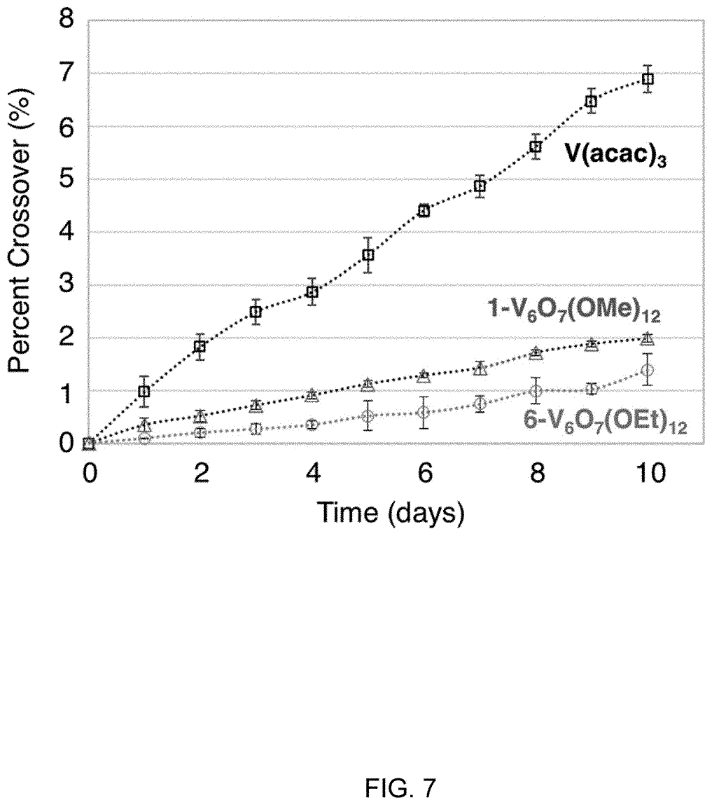

Identical experiments were conducted using a mononuclear charge carrier, vanadium(III) acetylacetonate (V(acac)₃), which serves as a reference for comparison with the polynuclear metal-oxide clusters. V(acac)₃ has established utility as a NRFB electrolyte, and is cited to partially mitigate crossover due to its bulky ligand framework (diameter of V(acac)₃=˜9.8 Å). [50, 61] For each test, an H-cell, divided by an anion exchange membrane (AMI-7001), was assembled with one half-cell containing 0.05 M of the electroactive species (1-V₆O₇(OMe)₁₂, 6-V₆O₇(OEt)₁₂, or V(acac)₃) and 0.5 M [NBu₄][PF₆], while the other half-cell contained solely the electrolyte, 0.5 M [NBu₄][PF₆]. The solutions were stirred at 1000 rpm, and the concentration of each side of the solution measured over 10 days using UV-vis spectroscopy. The average results over three trials are shown in FIG. 7. It is clear that not only does the bulky size of the POV-alkoxide clusters significantly reduce crossover when compared to V(acac)₃, but the increase in size from the methoxide bridged 1-V₆O₇(OMe)₁₂ to the ethoxide bridged 6-V₆O₇(OEt)₁₂ further mitigates the extent of crossover observed in these systems. This result demonstrates that a ligand substitution of bridging alkoxides on a self-assembled cluster can afford a measurable decrease in species crossover, thereby creating a NRFB cell with improved overall efficiency.

### PART 3: EXEMPLARY NON-AQUEOUS REDOX FLOW POV-ALKOXIDE CLUSTERS BATTERY

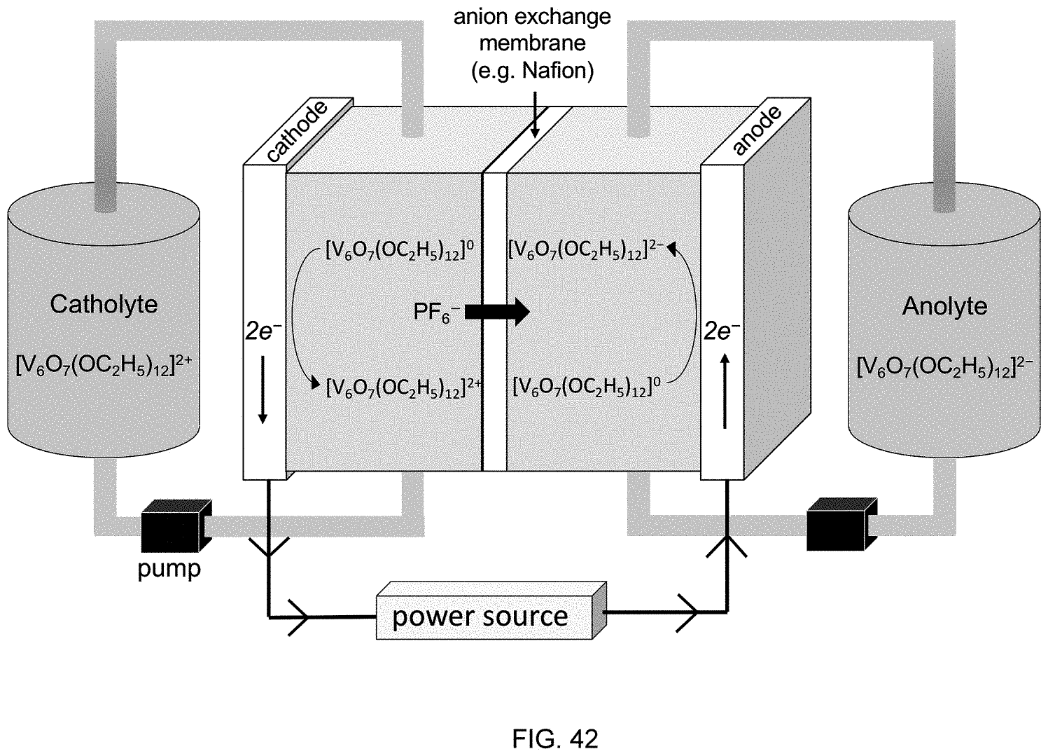

FIG. 42 shows an exemplary non-aqueous polyoxovanadate-alkoxide redox flow battery. FIG. 42 shows the battery being charged by an external power source. In a battery discharge condition, the cathode and anode act as the terminals of the battery as a battery source of power. The non-aqueous redox flow battery includes a negative electrode disposed within a non-aqueous liquid negative electrolyte tank. A positive electrode is disposed within a non-aqueous liquid positive electrolyte tank. A semi-permeable membrane is interposed between said non-aqueous liquid negative electrolyte tank and said liquid positive electrolyte tank. The at least one of said non-aqueous liquid negative electrolyte or said non-aqueous liquid positive electrolyte comprises POV-alkoxide clusters.

### PART 4 CONCLUSION

In this Application, we described how molecular control over POV-alkoxide clusters guides the formation of stable, multimetallic electroactive materials in non-aqueous media. The POV-alkoxide clusters reported are capable of cycling two electrons at both the anode and cathode of a symmetric H-cell. Although the methoxide-bridged cluster derivative 1-V₆O₇(OMe)₁₂ shows oxidative instability, the substitution of bridging ethoxide ligands (6-V₆O₇(OEt)₁₂) enhances the electrochemical properties of the hexavanadate core, resulting in a stable charge carrier. Furthermore, the large size of this series of POV-alkoxide clusters makes them resistant to membrane crossover, a feature that is also improved via ligand substitution from methoxide to ethoxide. Our combined synthetic and electroanalytic understanding of POV-alkoxides reveals the importance in cluster modifications, shedding light on the form-function relationships of this family of compounds with relevance to NRFBs. Current investigations in our laboratories are focused on further optimization of the physical and electrochemical properties of this class of polyoxometalates.

When evaluating the merit of new electroactive materials for NRFB applications, it is important to consider not only the physical properties of a complex, but also the accessibility of the molecule and feasibility of bulk synthesis. While previously reported metal coordination compounds have demonstrated fundamental advances in solubility as a result of systematic derivatization of the ligand, the assembly of these organic scaffolds requires multiple-step syntheses. [13, 24, 39] In contrast, the POV-alkoxide clusters reported here are accessible through a one-step synthesis from earth-abundant, commercially available starting materials. The crystalline electroactive molecule can be isolated on gram-scales directly from the reaction mixture. This advantageous feature of these cluster complexes represents a departure in synthetic approaches to the generation of charge carriers for NRFB technologies.

### PART 5: SUPPLEMENTAL INFORMATION

Experimental Details

General Considerations

All manipulations were carried out in the absence of water and oxygen in a UniLab MBraun inert atmosphere glovebox under a dinitrogen atmosphere. Glassware was oven dried for a minimum of 4 hours and cooled in an evacuated antechamber prior to use in the drybox. Anhydrous methanol was purchased from Sigma-Aldrich and stored over activated 4 Å molecular sieves purchased from Fisher Scientific. All other solvents were dried and deoxygenated on a Glass Contour System (Pure Process Technology, LLC) and stored over activated 3 Å molecular sieves purchased from Fisher Scientific. [NBu₄][BH₄] and VO(OⁱPr)₃ were purchased from Sigma-Aldrich and used as received. VO(OCH₃)₃ was synthesized according to previous literature. [62] [NBu₄][PF₆] was purchased from Sigma-Aldrich, recrystallized thrice using hot methanol, and stored under dynamic vacuum for a minimum of two days prior to use. ¹H NMR spectra were recorded at 500 on Bruker DPX-500 spectrometer locked on the signal of deuterated solvents. All chemical shifts were reported relative to the peak of residual ¹H signal in deuterated solvents. CD₃CN was purchased from Cambridge Isotope Laboratories, degassed by three freeze-pump-thaw cycles, and stored over activated 4 Å molecular sieves. Infrared (FT-IR, ATR) spectra of complexes were recorded on a Shimadzu IRAffinity-1 Fourier Transform Infrared Spectrophotometer and are reported in wavenumbers (cm⁻¹). Electronic absorption measurements were recorded at room temperature in anhydrous acetonitrile in a sealed 1 cm quartz cuvette with an Agilent Cary 60 UV-Vis spectrophotometer.

POV-Alkoxide Syntheses.

The active species, 1-V₆O₇(OMe)₁₂ was accessed from one of two methods. The first is the previous synthetic route established by Hard and coworkers [43], and the second is a modified procedure designed to access the molecule directly from commercially available reagents.

Synthesis of 1-V₆O₇(OMe)₁₂ from Commercial Starting Materials.

In the glovebox, VO(OCH(CH₃)₂)₃ (510 mg, 2.08 mmol), [NBu₄][BH₄] (53.7 mg, 0.208 mmol) and 14 mL methanol were charged in a 25 mL Teflon-lined Parr reactor. The Parr reactor was sealed, and the mixture heated in an over at 125° C. for 24 hours. The Parr reactor was allowed to cool to room temperature. Subsequent workup was conducted on the bench top. The resulting dark green solution was rotary evaporated to reduce the volume by half, then placed in a freezer at 35° C. for 24 hours. The resulting dark green crystals were spectroscopically pure 1-V₆O₇(OMe)₁₂ (231.289 mg, 0.293 mmol, 70.1%). The crystallization procedure was repeated twice to improve the yield (294.710 g, 0.373 mmol, 89.3%). Characterization matches the previously reported synthesis. [43]

Complexes 2-V₆O₇(OMe)₁₂²⁻ and 3-V₆O₇(OMe)₁₂⁻ were prepared and characterized according to the literature. [41] The monocationic complex, 4-V₆O₇(OMe)₁₂⁺, has been reported previously [41], however was prepared here using an alternate method:

Synthesis of 4-V₆O₇(OMe)₁₂⁺.

In the glovebox, silver hexafluorophosphate (AgPF₆, 66 mg, 0.260 mmol) was added to a solution of 1-V₆O₇(OMe)₁₂ (200 mg, 0.253 mmol) in dichloromethane (10 mL). This solution was stirred for 1 hour, after which it was filtered and then evaporated to dryness. The green solid 4-V₆O₇(OMe)₁₂⁺ was obtained in good yield (184 mg, 0.196 mmol, 77.4%). Characterization of this product matches that for the previously reported synthesis. [41]

Complex 6-V₆O₇(OEt)₁₂ was prepared and characterized according to the previous literature. [43]

Complexes 7-V₆O₇(OEt)₁₂²⁻ and 8-V₆O₇(OEt)₁₂⁻ had not been reported previously, and were prepared and characterized as follows:

Synthesis of 7-V₆O₇(OEt)₁₂²⁻.

In the glove box, [NBu₄][BH₄] (108 mg, 0.420 mmol) was added to a solution of 6-V₆O₇(OEt)₁₂ (200 mg, 0.209 mmol) in acetonitrile (10 mL). This solution was allowed to stir for 1.5 hours, at which time the color had changed from dark green to teal blue. This solution was evaporated to half of its original volume and placed in the freezer. After 24 hours, dark blue-green crystals of 7-V₆O₇(OEt)₁₂²⁻ precipitated from the solution (125 mg, 0.087 mmol, 41.6%). ¹H NMR (400 MHz, CD₂Cl₂): δ=1.00 (s) 1.49 (s) 1.64 (s), 3.37 (s) 26.34 (br). FT-IR (ATR, cm⁻¹) 737, 889, 922, 1063, 1170, 1183, 1474, 1622, 1673. UV-Vis (CH₃CN) [ε (M⁻¹cm⁻¹)]: 324 nm (5.150×10³)

Synthesis of 8-V₆O₇(OEt)₁₂⁻.

In the glovebox, VO(OC₂H₅)₃ (392 mg, 1.939 mmol), [NBu₄][BH₄] (105 mg, 0.408 mmol) and 14 mL methanol were charged in a 25 mL Teflon-lined Parr reactor. The Parr reactor was sealed, and the mixture heated in an over at 125° C. for 24 hours. The Parr reactor was allowed to cool to room temperature, and returned to the glove box. The resulting solution was evaporated to dryness, and washed with hexanes until the washes were colorless. The dark green solid 8-V₆O₇(OEt)₁₂⁻ was obtained in good yield (295 mg, 0.246 mmol, 76.0%). ¹H NMR (400 MHz, CD₂Cl₂): δ=1.59 (s) 1.01 (s) 1.64 (s) 3.43 (s) 23.42 (br). FT IR (ATR, cm⁻¹) 734, 883, 951, 1028, 1169, 1379, 1460. UV-Vis (CH₃CN) [ε (M⁻¹cm⁻¹)]: 318 nm (5.877×10³)

The syntheses of complexes 9-V₆O₇(OEt)₁₂⁺ and 10-V₆O₇(OEt)₁₂²⁺ were reported previously [43], however were prepared here using alternate synthetic routes:

Synthesis of 9-V₆O₇(OEt)₁₂⁺.

In the glovebox, silver hexafluorophosphate (AgPF₆, 53 mg, 0.210 mmol), was added to a solution of 6-V₆O₇(OEt)₁₂ (200 mg, 0.209 mmol) in dichloromethane (10 mL). The solution was allowed to stir for 1 hour, after which it was filtered and evaporated to dryness. This crude product was washed with hexanes (3×10 mL) leaving the green solid 9-V₆O₇(OEt)₁₂⁺ (168 mg, 0.152 mmol, 72.7%). Characterization of this product matches that for the previously reported synthesis. [43]

Synthesis of 10-V₆O₇(OEt)₁₂²⁺.

In the glovebox, nitrosonium hexafluorophosphate (NOPF₆, 74 mg, 0.420 mmol) was added to a solution of 6-V₆O₇(OEt)₁₂ (200 mg, 0.209 mmol) in dichloromethane (10 mL). The solution was allowed to stir for one hour, after which a solid green precipitate formed. This precipitate was collected via filtration and washed with ether (3×10 mL). The resulting light green solid 10-V₆O₇(OEt)₁₂²⁺ was formed in moderate yield (59 mg, 0.047 mmol, 22.4%). Characterization of this product matches that for the previously reported synthesis. [43]

Electrochemistry.

Cyclic Voltammetry Experiments.

Concentrations of POV-alkoxide and [NBu₄][PF₆] used were 1 mM and 100 mM, respectively. CV measurements were carried out inside a nitrogen filled glove box (Vigor Tech, USA) using a Bio-Logic SP 200 potentiostat/galvanostat and the EC-Lab software suite. Cyclic voltammograms were recorded using a 3 mm diameter glassy carbon working electrode (CH Instruments, USA), a Pt wire auxiliary electrode (CH Instruments, USA), and a Ag/Ag⁺ non-aqueous reference electrode with 0.01 M AgNO₃ in 0.05 M [NBu₄][PF₆] in CH₃CN (BASi, USA). Cyclic voltammograms were iR compensated at 85% with impedance taken at 100 kHz using the ZIR tool included within the EC-Lab software.

Diffusion coefficients associated with each redox couple was determined by using the slope of the peak current (iₙ) versus the square root of scan rate v^{1/2}. The Randles-Sevcik equation was used to estimate the diffusion coefficients from CV data. For a reversible redox couple, the peak current is given by the eq. 51;

iₚ=2.69×10⁵n^{3/2}AcD₀^{1/2}v^{1/2} Eq. S1

In eq. 51, n is the number of electrons transferred; A is the electrode area (0.0707 cm² for the glassy carbon working electrode); c is the bulk concentration of the active species; D₀ is the diffusion coefficient of the active species; v is the scan rate. For an irreversible redox couple, the peak current, is given by the eq. S2:

iₚ=2.99×10⁵n^{3/2}α^{1/2}AcD₀^{1/2}v Eq. S2

where α is the charge transfer coefficient (α˜0.5).

For the redox couples that show quasi-reversible kinetics, relationships for both reversible and irreversible redox reaction are usually employed to determine the diffusion coefficients of such redox processes. Therefore, an average value of diffusion coefficient was approximated for a quasi-reversible redox couple using both equations S1 and S2. [40, 49, 50]

The Heterogeneous Electron-Transfer (ET) Rate Constants were calculated using the Nicholson method. [52] The potential difference (ΔEp) of oxidation and reduction peaks were obtained at different scan rates. The transfer parameter, ψ, was extracted from the working curve constructed by Nicholson using ΔEp values. The standard heterogeneous charge transfers rate constant, k₀, for the electron transfer process was determined using the following equation:

$$ψ = \frac{{k}_{0}}{{( \frac{π nFDv}{RT} )}^{1 / 2}} \qquad Eq . S3$$

where n is the number of electrons transferred, F is the Faraday constant, D is the diffusion coefficient, v is the scan rate, R is the ideal gas constant and T is the temperature. [52, 62].

Chronoamperometry/Bulk Electrolysis Experiments

Bulk electrolysis experiments were performed in a H-cell with a glass frit separator (Porosity=10-16 μm, Adams and Chittenden, USA) using a Bio-Logic SP 200 potentiostat/galvanostat. An active species concentration of 1 mM was used. Working electrode compartment contained 5 mL of the active species with 100 mM [NBu₄][PF₆] in CH₃CN and counter electrode compartment had 5 mL of 100 mM [NBu₄][PF₆] in CH₃CN. A Pt mesh working electrode and a Pt wire counter electrode were used. Bulk electrolysis experiments were carried out using the chronoamperometry techniques available in EC lab software suite at constant potentials, selected from the CV data.

Charge-Discharge Experiments

Charge-discharge testing was done in a nitrogen filled glove box using a glass H-cell (Adams and Chittenden, USA) and a Bio-Logic SP 150 potentiostat/galvanostat. The electrolyte solutions used in charge-discharge experiments were 0.01 M active species in 0.5 M [NBu₄][PF₆] in CH₃CN. Each compartment of the H-cell was filed with 15.0 mL of the electrolyte solution. The compartments of the H-cell were separated by an AMI-7001 anion exchange membrane (˜0.05 cm², Membrane International Inc., USA). Two graphite felt electrodes (2×1×0.5 cm, Fuel Cell Store, USA) were placed in the posolyte and negolyte chambers. Electrodes attached to Pt wire current collectors submerged in the electrolyte solutions (˜0.5 cm). Membranes and graphite felt electrodes were soaked in electrolyte solutions for 24 hours before each experiment. A galvanostatic charge-discharge method was adopted using a charging current of 0.2 mA and a discharging current of 0.02 mA for each experiment. The charge voltage cut offs were 2.0 V for the two separate experiments, both involving all four redox couples. The discharge cutoff voltage was 0.5 V for 1-V₆O₇(OCH₃)₁₂ and 0.6 V for 6-V₆O₇(OC₂H₅)₁₂. For the duration of the charge-discharge experiments, both half cells were stirring at approximately 1,000 rpm.

FIG. 8 shows CV cycling of 1.0 mM 1-V₆O₇(OMe)₁₂ in MeCN with 0.1 M [NBu₄][PF₆] supporting electrolyte. Scan rate 100 mV/s. Duration of cycling approximately one hour.

FIG. 9A shows a CV of 1 mM 1-V₆O₇ in MeCN with 0.1 M [NBu₄][PF₆] supporting electrolyte at various scan rates. FIG. 9B shows a CV of only the most reducing redox-event (R2) of 1-V₆O₇. Each redox event is isolated to determine iₚ and ΔE values for use in diffusion coefficient (D₀) and heterogeneous electron transfer rate constant (k₀) calculations.

FIG. 10A shows a plot of iₚ vs. (v)^{1/2} and FIG. 10B shows a plot of ΔE vs. (v)^{1/2} for the second reduction event (E_{1/2}=−0.72V) of 1-V₆O₇(OMe)₁₂.

FIG. 11A shows a plot of iₚ vs. (v)^{1/2} and FIG. 11B shows a plot of ΔE vs. (v)^{1/2} for the first reduction event (E_{1/2}=−0.22 V) of 1-V₆O₇(OMe)₁₂.

FIG. 12A shows a plot of iₚ vs. (v)^{1/2} and FIG. 12B shows a plot of ΔE vs. (v)^{1/2} for the first oxidation event (E_{1/2}=+0.30 V) of 1-V₆O₇(OMe)₁₂.

FIG. 13A shows a plot of iₚ vs. (v)^{1/2} and FIG. 14A shows a plot of ΔE vs. (v)^{1/2} for second oxidation event (E_{1/2}=+0.85 V) of 1-V₆O₇(OMe)₁₂.

FIG. 14A shows cyclic voltammograms at 100 mV/s and FIG. 14B shows absorption spectra of a 1 mM solution of 2-V₆O₇(OMe)₁₂²⁻ with 0.1 M [NBu₄][PF₆] in acetonitrile over the course of a week.

FIG. 15A shows cyclic voltammograms at 100 mV/s and FIG. 15B shows absorption spectra of a 1 mM solution of 3-V₆O₇(OMe)₁₂⁻ with 0.1 M [NBu₄][PF₆] in acetonitrile over the course of a week.

FIG. 16A shows cyclic voltammograms at 100 mV/s and FIG. 16B shows absorption spectra of a 1 mM solution of 1-V₆O₇(OMe)₁₂ with 0.1 M [NBu₄][PF₆] in acetonitrile over the course of a week.

FIG. 17A shows Cyclic voltammograms at 100 mV/s and FIG. 17B shows absorption spectra of a 1 mM solution of 4-V₆O₇(OMe)₁₂⁺ with 0.1 M [NBu₄][PF₆] in acetonitrile over the course of a week.

FIG. 18A (graph) and FIG. 18B (CV plot) show bulk oxidation (+1.1 V) of 1-V6O7(OMe)12 in MeCN.

FIG. 19A shows absorbance spectra of 2-V₆O₇(OMe)₁₂²⁻ at various concentrations in MeCN with 0.1 M [NBu₄][PF₆] and FIG. 19B shows a Beer's Law plot of absorbance at 626 nm for 2-V₆O₇(OMe)₁₂²⁻ in MeCN.

For FIG. 19A and FIG. 19B:

Molar Absorptivity at 626 nm: 50.3 M⁻¹cm⁻¹

| saturated solution 1: | saturated solution 2: | saturated solution 3: |
|---|---|---|
| Diluted 200uL to 5 mL MeCN | Diluted 200uL to 5 mL MeCN | Diluted 200uL to 5 mL MeCN |
| A = 0.222605 | A = 0.22048 | A = 0.20776 |
| C = 4.2001 E-3 M | C = 4.16 E-3 M | C = 3.9218 E-3 M |
| 5 mL(M) = .200 mL X M | 5 mL(M) = .200 mL X M | 5 mL(3.9218 E-3 M) = .200 mL X M |
| X = 0.105 M | X = 0.104 M | X = 0.098 M |
| | | Average solubility = 102 mM |

FIG. 20A shows absorbance spectra of 3-V₆O₇(OMe)₁₂⁻ at various concentrations in MeCN with 0.1 M [NBu₄][PF₆] and FIG. 20B shows a Beer's Law plot of absorbance at 378 nm for 3-V₆O₇(OMe)₁₂⁻ in MeCN.

For FIG. 20A and FIG. 20B:

Molar Absorptivity at 378 nm: 3,668.7 M⁻¹cm⁻¹

| saturated solution 1: | saturated solution 2: | saturated solution 3: |
|---|---|---|
| Diluted 5uL to 5 mL MeCN | Diluted 5uL to 5 mL MeCN | Diluted 5uL to 5 mL MeCN |
| A = .684129 | A = .693158 | A = .715259 |
| C = 1.865 E-4 | C = 1.889 E-4 | C = 1.950 E-4 |
| 5 mL(1.865 E-4 M) = .005 mL X M | 5 mL(1.889 E-4 M) = .005 mL X M | 5 mL(1.950 E-4 M) = .005 mL X M |
| X = 0.1865 M | X = 0.1889 M | X = 0.1950 M |
| | | Average solubility = 190 mM |

FIG. 21A shows absorbance spectra of 1-V₆O₇(OMe)₁₂ at various concentrations in MeCN with 0.1 M [NBu₄][PF₆] and FIG. 21B shows a Beer's Law plot of absorbance at 382 for 1-V₆O₇(OMe)₁₂ in MeCN.

For FIG. 21A and FIG. 21B:

Molar Absorptivity at 382 nm: 9001.1 M⁻¹ cm⁻¹

| saturated solution 1: | saturated solution 2: | saturated solution 3: |
|---|---|---|
| Diluted 5uL to 10 mL MeCN | Diluted 5uL to 10 mL MeCN | Diluted 5uL to 10 mL MeCN |
| A = 0.918122 | A = 0.927113 | A = 0.882108 |
| C = 1.02 E-4 M | C = 1.03 E-4 | C = 1.96 E-5 M |
| 10 mL(1.02 E-4 M) = .005 mL X M | 10 mL(1.03 E-4 M) = .005 mL X M | 10 mL(1.96 E-4 M) = .005 mL X M |
| X = .204 M | X = .206 M | X = .196 M |
| | | Average solubility = 202 mM |

FIG. 22A shows absorbance spectra of 4-V₆O₇(OMe)₁₂⁺ at various concentrations in MeCN with 0.1 M [NBu₄][PF₆] and FIG. 22B shows a Beer's Law plot of absorbance at 382 for 4-V₆O₇(OMe)₁₂⁺ in MeCN.

For FIG. 22A and FIG. 22B:

Molar Absorptivity at 382 nm: 14,632 M⁻¹cm⁻¹

| saturated solution 1: | saturated solution 2: | saturated solution 3: |
|---|---|---|
| Diluted 2.5uL to 10 mL MeCN | Diluted 2.5uL to 10 mL MeCN | Diluted 2.5uL to 10 mL MeCN |
| A = 0.68404 | A = 0.691362 | A = 0.643808 |
| C = 4.675 E-5 | C = 4.725 E-5 M | C = 4.4 E-5 M |
| 10 mL(4.675 E-5 M) = .0025 mL X M | 10 mL(4.725 E-5 M) = .0025 mL X M | 10 mL(4.4 E-5 M) = .0025 mL X M |
| X = 0.187 M | X = 0.189 M | X = 0.176 M |
| | | Average solubility = 184 mM |

FIG. 23 shows a CV of catholyte solution of 1-V₆O₇(OCH₃)₁₂ before and after charge discharge cycling at 2 V cutoff potential.

FIG. 24 shows a CV cycling of 1 mM 6-V₆O₇(OEt)₁₂ in acetonitrile with 0.1 M [NBu₄][PF₆] supporting electrolyte.

FIG. 25A shows a plot of iₚ vs. (v)^{1/2} and FIG. 25B shows a plot of ΔE vs. (v)^{1/2} for the second reduction event (E_{1/2}=−0.88 V) of 6-V₆O₇(OEt)₁₂.

FIG. 26A shows a plot of iₚ vs. (v)^{1/2} and FIG. 26B shows a plot of ΔE vs. (v)^{1/2} for the first oxidation event (E_{1/2}=+0.34 V) of 6-V₆O₇(OEt)₁₂.

FIG. 27A shows a plot of iₚ vs. (v)^{1/2} and FIG. 27B shows a plot of ΔE vs. (v)^{1/2} for the first oxidation event (E_{1/2}=+0.22 V) of 6-V₆O₇(OEt)₁₂.

FIG. 28A shows a plot of iₚ vs. (v)^{1/2} and FIG. 28B shows a plot of ΔE vs. (v)^{1/2} for the second oxidation event (E_{1/2}=+0.79 V) of 6-V₆O₇(OEt)₁₂.

FIG. 29A shows absorbance spectra of 7-V₆O₇(OEt)₁₂²⁻ at various concentrations in MeCN with 0.1 M [NBu₄][PF₆] and FIG. 29B shows a Beer's Law plot of absorbance at 626 nm for 7-V₆O₇(OEt)₁₂²⁻ in MeCN.

For FIG. 29A and FIG. 29B:

Molar Absorptivity at 323 nm: 5,069 M⁻¹cm⁻¹

| Saturated Solution 1: | Saturated Solution 2: | Saturated Solution 3: |
|---|---|---|
| Diluted 2.5 uL to 10 mL MeCN | Diluted 2.5 uL to 10 mL MeCN | Diluted 2.5 uL to 10 mL MeCN |
| A = 0.13052 | A = 0.15207 | A = 0.13813 |
| C = 2.575 E-5 M | C = 3.00 E-5 M | C = 2.725 E-5 M |
| 10 mL(2.575 E-5 M) = 2.5 uL (X M) | 10 mL(3.00 E-5 M) = 2.5 uL (X M) | 10 mL(2.725 E-5 M) = 2.5 uL (X M) |
| X = 0.103 M | X = 0.120 M | X = 0.109 M |
| | | Average Solubility = 111 mM |

FIG. 30A shows absorbance spectra of 8-V₆O₇(OEt)₁₂⁻ at various concentrations in MeCN with 0.1 M [NBu₄][PF₆] and FIG. 30B shows a Beer's Law plot of absorbance at 626 nm for 8-V₆O₇(OEt)₁₂⁻ in MeCN.

For FIG. 30A and FIG. 30B:

Molar Absorptivity at 325 nm: 5,971 M⁻¹cm⁻¹

| Saturated Solution 1: | Saturated Solution 2: | Saturated Solution 3: |
|---|---|---|
| Diluted 2.5 uL to 10 mL MeCN | Diluted 2.5 uL to 10 mL MeCN | Diluted 2.5 uL to 10 mL MeCN |
| A = 0.34333 | A = 0.33587 | A = 0.32691 |
| C = 5.750 E-5 M | C = 5.625 E-5 M | C = 5.475 E-5 M |
| 10 mL(5.750 E-5 M) = 2.5 uL (X M) | 10 mL(5.625 E-5 M) = 2.5 uL (X M) | 10 mL(5.475 E-5 M) = 2.5 uL (X M) |
| X = 0.230 M | X = 0.225 M | X = 0.219 M |
| | | Average Solubility = 225 mM |

FIG. 31A shows absorbance spectra of 6-V₆O₇(OEt)₁₂ at various concentrations in MeCN with 0.1 M [NBu₄][PF₆] and FIG. 31A shows a Beer's Law plot of absorbance at 626 nm for 6-V₆O₇(OEt)₁₂ in MeCN.

For FIG. 31A and FIG. 31B:

Molar Absorptivity at 325 nm: 6,787 M⁻¹cm⁻¹

| Saturated Solution 1: | Saturated Solution 2: | Saturated Solution 3: |
|---|---|---|
| Diluted 10 uL to 10 mL MeCN | Diluted 10 uL to 10 mL MeCN | Diluted 10 uL to 10 mL MeCN |
| A = 0.29190 | A = 0.37559 | A = 0.32224 |
| C = 4.301 E-5 M | C = 5.534 E-5 M | C = 4.748 E-5 M |
| 10 mL(4.301 E-5 M) = 10 uL (X M) | 10 mL(5.534 E-5 M) = 10 uL (X M) | 10 mL(4.748 E-5 M) = 10 uL (X M) |
| X = 0.043 M | X = 0.055 M | X = 0.047 M |
| | | Average Solubility = 48 mM |

FIG. 32A shows absorbance spectra of 9-V₆O₇(OEt)₁₂⁺ at various concentrations in MeCN with 0.1 M [NBu₄][PF₆] and FIG. 32A shows a Beer's Law plot of absorbance at 626 nm for 9-V₆O₇(OEt)₁₂⁺ in MeCN.

For FIG. 32A and FIG. 32B:

Molar Absorptivity at 325 nm: 7,767 M⁻¹cm⁻¹

| Saturated Solution 1: | Saturated Solution 2: | Saturated Solution 3: |
|---|---|---|
| Diluted 2.5 uL to 10 mL MeCN | Diluted 2.5 uL to 10 mL MeCN | Diluted 2.5 uL to 10 mL MeCN |
| A = 0.38640 | A = 0.39619 | A = 0.41553 |
| C = 4.975 E-5 M | C = 5.101 E-5 M | C = 5.350 E-5 M |
| 10 mL(4.975 E-5 M) = 2.5 uL (X M) | 10 mL(5.101 E-5 M) = 2.5 uL (X M) | 10 mL(5.350 E-5 M) = 2.5 uL (X M) |
| X = 0.199 M | X = 0.204 M | X = 0.214 M |
| | | Average Solubility = 206 mM |

FIG. 33A shows absorbance spectra of 10-V₆O₇(OEt)₁₂²⁺ at various concentrations in MeCN with 0.1 M [NBu₄][PF₆] and FIG. 33A shows a Beer's Law plot of absorbance at 626 nm for 10-V₆O₇(OEt)₁₂²⁺ in MeCN.

For FIG. 33A and FIG. 33B:

Molar Absorptivity at 325 nm: 9,803 M⁻¹cm⁻¹

| Saturated Solution 1: | Saturated Solution 2: | Saturated Solution 3: |
|---|---|---|
| Diluted 2.5 uL to 10 mL MeCN | Diluted 2.5 uL to 10 mL MeCN | Diluted 2.5 uL to 10 mL MeCN |
| A = 0.31869 | A = 0.34555 | A = 0.321048 |
| C = 3.251 E-5 M | C = 3.525 E-5 M | C = 3.275 E-5 M |
| 10 mL(3.251 E-5 M) = 2.5 uL (X M) | 10 mL(3.525 E-5 M) = 2.5 uL (X M) | 10 mL(3.275 E-5 M) = 2.5 uL (X M) |
| X = 0.130 M | X = 0.141 M | X = 0.131 M |
| | | Average Solubility = 134 mM |

FIG. 34A shows a graph of UV-vis in acetonitrile and FIG. 34B shows a graph of infrared absorption spectra of all charge states of 6-V₆O₇(OEt)₁₂.

FIG. 35A shows cyclic voltammograms at 100 mV/s and FIG. 35B shows absorption spectra of a 1 mM solution of 7-V₆O₇(OEt)₁₂²⁻ with 0.1 M [NBu₄][PF₆] in acetonitrile over the course of a week.

FIG. 36A shows cyclic voltammograms at 100 mV/s and FIG. 36B shows absorption spectra of a 1 mM solution of 8-V₆O₇(OEt)₁₂⁻ with 0.1 M [NBu₄][PF₆] in acetonitrile over the course of a week.

FIG. 37A shows cyclic voltammograms at 100 mV/s and FIG. 37B shows absorption spectra of a 1 mM solution of 6-V₆O₇(OEt)₁₂ with 0.1 M [NBu₄][PF₆] in acetonitrile over the course of a week.

FIG. 38A shows cyclic voltammograms at 100 mV/s and FIG. 38B shows absorption spectra of a 1 mM solution of 9-V₆O₇(OEt)₁₂⁺ with 0.1 M [NBu₄][PF₆] in acetonitrile over the course of a week.

FIG. 39A shows cyclic voltammograms at 100 mV/s and FIG. 39B shows absorption spectra of a 1 mM solution of 6-V₆O₇(OEt)₁₂²⁺ with 0.1 M [NBu₄][PF₆] in acetonitrile over the course of a week.

FIG. 40A shows a graph of Bulk oxidation (+1.1 V) of 0.1 mM 6-V₆O₇(OEt)₁₂ in acetonitrile with 0.1 M [NBu₄][PF₆] supporting electrolyte and FIG. 40B shows a CV plot of the solution before and after the oxidation.

Modeling and analysis software as described herein can be provided on a computer readable non-transitory storage medium. A computer readable non-transitory storage medium as non-transitory data storage includes any data stored on any suitable media in a non-fleeting manner Such data storage includes any suitable computer readable non-transitory storage medium, including, but not limited to hard drives, non-volatile RAM, SSD devices, CDs, DVDs, etc.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

### REFERENCES

1. Z. Yang, J. Zhang, M. C. W. Kintner-Meyer, X. Lu, D. Choi, J. P. Lemmon and J. Liu, Chemical Reviews, 2011, 111, 3577-3613.
2. G. L. Soloveichik, Chemical Reviews, 2015, 115, 11533-11558.
3. Q. Huang and Q. Wang, ChemPlusChem, 2015, 80, 312-322.
4. P. Alotto, M. Guarnieri and F. Moro, Renewable and Sustainable Energy Reviews, 2014, 29, 325-335.
5. R. M. Darling, K. G. Gallagher, J. A. Kowalski, S. Ha and F. R. Brushett, Energy & Environmental Science, 2014, 7, 3459-3477.
6. S.-H. Shin, S.-H. Yun and S.-H. Moon, RSC Advances, 2013, 3, 9095-9116.
7. S. Er, C. Suh, M. P. Marshak and A. Aspuru-Guzik, Chemical Science, 2015, 6, 885-893.
8. C. S. Sevov, S. L. Fisher, L. T. Thompson and M. S. Sanford, Journal of the American Chemical Society, 2016, 138, 15378-15384.
9. B. Dunn, H. Kamath and J.-M. Tarascon, Science, 2011, 334, 928-935.
10. T. Nguyen and R. F. Savinell, The Electrochemical Society Interface, 2010, 19, 54-56.
11. C. Ponce de León, A. Frías-Ferrer, J. González-García, D. A. Szánto and F. C. Walsh, Journal of Power Sources, 2006, 160, 716-732.
12. J. A. Suttil, J. F. Kucharyson, I. L. Escalante-Garcia, P. J. Cabrera, B. R. James, R. F. Savinell, M. S. Sanford and L. T. Thompson, Journal of Materials Chemistry A, 2015, 3, 7929-7938.
13. P. J. Cabrera, X. Yang, J. A. Suttil, K. L. Hawthorne, R. E. M. Brooner, M. S. Sanford and L. T. Thompson, The Journal of Physical Chemistry C, 2015, 119, 15882-15889.
14. P. J. Cabrera, X. Yang, J. A. Suttil, R. E. M. Brooner, L. T. Thompson and M. S. Sanford, Inorganic Chemistry, 2015, 54, 10214-10223.
15. Y. Matsuda, K. Tanaka, M. Okada, Y. Takasu, M. Morita and T. Matsumura-Inoue, Journal of Applied Electrochemistry, 1988, 18, 909-914.
16. M. Masayuki, T. Yoshinori, T. Keisuke, M. Yoshiharu and M.-I. Takeko, Bulletin of the Chemical Society of Japan, 1988, 61, 2711-2714.
17. J. Mun, M.-J. Lee, J.-W. Park, D.-J. Oh, D.-Y. Lee and S.-G. Doo, Electrochemical and Solid-State Letters, 2012, 15, A80-A82.
18. P. J. Mahon, Electrochimica Acta, 2011, 56, 2190-2200.
19. M. H. Chakrabarti, R. A. W. Dryfe and E. P. L. Roberts, Electrochimica Acta, 2007, 52, 2189-2195.
20. J.-H. Kim, K. J. Kim, M.-S. Park, N. J. Lee, U. Hwang, H. Kim and Y.-J. Kim, Electrochemistry Communications, 2011, 13, 997-1000.
21. M. H. Chakrabarti, E. P. Lindfield Roberts and M. Saleem, International Journal of Green Energy, 2010, 7, 445-460.
22. M.-S. Park, N.-J. Lee, S.-W. Lee, K. J. Kim, D.-J. Oh and Y.-J. Kim, ACS Applied Materials & Interfaces, 2014, 6, 10729-10735.
23. X. Xing, D. Zhang and Y. Li, Journal of Power Sources, 2015, 279, 205-209.
24. G. M. Duarte, J. D. Braun, P. K. Giesbrecht and D. E. Herbert, Dalton Transactions, 2017, 46, 16439-16445.
25. P. J. Cappillino, H. D. Pratt, N. S. Hudak, N. C. Tomson, T. M. Anderson and M. R. Anstey, Advanced Energy Materials, 2014, 4, 1300566-n/a.
26. Y.-F. Song and R. Tsunashima, Chem. Soc. Rev., 2012, 41, 7384-7402.
27. A. Dolbecq, E. Dumas, C. R. Mayer and P. Mialane, Chemical Reviews, 2010, 110, 6009-6048.
28. A. Müller, F. Peters, M. T. Pope and D. Gatteschi, Chemical Reviews, 1998, 98, 239-272.
29. S. Omwoma, W. Chen, R. Tsunashima and Y.-F. Song, Coordination Chemistry Reviews, 2014, 258-259, 58-71.
30. S.-S. Wang and G.-Y. Yang, Chemical Reviews, 2015, 115, 4893-4962.
31. Y. Ji, L. Huang, J. Hu, C. Streb and Y.-F. Song, Energy & Environmental Science, 2015, 8, 776-789.
32. M. Sadakane and E. Steckhan, Chemical Reviews, 1998, 98, 219-238.
33. H. D. Pratt, N. S. Hudak, X. Fang and T. M. Anderson, Journal of Power Sources, 2013, 236, 259-264.
34. J.-J. J. Chen and M. A. Barteau, Industrial & Engineering Chemistry Research, 2016, 55, 9857-9864.
35. J.-J. J. Chen and M. A. Barteau, Journal of Energy Storage, 2017, 13, 255-261.
36. S. Herrmann, J. T. Margraf, T. Clark and C. Streb, Chemical Communications, 2015, 51, 13702-13705.
37. S. HERRMANN, A. SELIVERSTOV and C. STREB, Journal of Molecular and Engineering Materials, 2014, 02, 1440001.
38. J. Winsberg, T. Hagemann, T. Janoschka, M. D. Hager and U. S. Schubert, Angewandte Chemie International Edition, 2017, 56, 686-711.
39. C. S. Sevov, R. E. M. Brooner, E. Chenard, R. S. Assary, J. S. Moore, J. Rodriguez-Lopez and M. S. Sanford, Journal of the American Chemical Society, 2015, 137, 14465-14472.
40. A. M. Kosswattaarachchi, A. E. Friedman and T. R. Cook, ChemSusChem, 2016, 9, 3317-3323.
41. J. Spandl, C. Daniel, I. Brudgam and H. Hartl, Angew. Chem., Int. Ed., 2003, 42, 1163-1166.
42. V. G. Kessler and G. A. Seisenbaeva, Inorganic Chemistry Communications, 2000, 3, 203-204.
43. C. Daniel and H. Hartl, Journal of the American Chemical Society, 2005, 127, 13978-13987.
44. R. A. Potash, J. R. McKone, S. Conte and H. D. Abruña, Journal of The Electrochemical Society, 2016, 163, A338-A344.
45. W. Duan, R. S. Vemuri, J. D. Milshtein, S. Laramie, R. D. Dmello, J. Huang, L. Zhang, D. Hu, M. Vijayakumar, W. Wang, J. Liu, R. M. Darling, L. Thompson, K. Smith, J. S. Moore, F. R. Brushett and X. Wei, Journal of Materials Chemistry A, 2016, 4, 5448-5456.
46. K. J. Vetter, Electrochemical Kinetics, Theoretical Aspects, Academic Press, New York, N.Y., 1 edn., 1967.
47. J. F. Walling, Journal of Chemical Education, 1968, 45, A142.
48. Q. Liu, A. A. Shinkle, Y. Li, C. W. Monroe, L. T. Thompson and A. E. S. Sleightholme, Electrochemistry Communications, 2010, 12, 1634-1637.
49. A. E. S. Sleightholme, A. A. Shinkle, Q. Liu, Y. Li, C. W. Monroe and L. T. Thompson, Journal of Power Sources, 2011, 196, 5742-5745.
50. Q. Liu, A. E. S. Sleightholme, A. A. Shinkle, Y. Li and L. T. Thompson, Electrochemistry Communications, 2009, 11, 2312-2315.
51. M. E. Ortiz, L. J. Núñez-Vergara and J. A. Squella, Journal of Electroanalytical Chemistry, 2003, 549, 157-160.
52. R. S. Nicholson and I. Shain, Analytical Chemistry, 1964, 36, 706-723.
53. A. Z. Weber, M. M. Mench, J. P. Meyers, P. N. Ross, J. T. Gostick and Q. Liu, Journal of Applied Electrochemistry, 2011, 41, 1137.
54. Y. Ding, Y. Zhao, Y. Li, J. B. Goodenough and G. Yu, Energy & Environmental Science, 2017, 10, 491-497.
55. J. Spandl, C. Daniel, I. Brildgam and H. Hartl, Angewandte Chemie International Edition, 2003, 42, 1163-1166.
56. X. Xing, D. Zhang and Y. Li, Journal of Power Sources, 2015, 279, 205-209.
57. D. Zhang, H. Lan and Y. Li, Journal of Power Sources, 2012, 217, 199-203.
58. S. E. Doris, A. L. Ward, A. Baskin, P. D. Frischmann, N. Gavvalapalli, E. Chenard, C. S. Sevov, D. Prendergast, J. S. Moore and B. A. Helms, Angewandte Chemie International Edition, 2017, 56, 1595-1599.
59. R. M. Darling, A. Z. Weber, M. C. Tucker and M. L. Perry, Journal of The Electrochemical Society, 2016, 163, A5014-A5022.
60. M. O. Bamgbopa and S. Almheiri, Journal of Power Sources, 2017, 342, 371-381.
61. E. Arslan, R. A. Lalancette and I. Bernal, Structural Chemistry, 2017, 28, 201-212.
62. Hoppe, E.; Limberg, C.; Ziemer, B., Mono- and Dinuclear Oxovanadium(V)calixarene Complexes and Their Activity as Oxidation Catalysts. Inorganic Chemistry 2006, 45 (20), 8308-8317.
63. Muhammad, H.; Tahiri, I. A.; Muhammad, M.; Masood, Z.; Versiani, M. A.; Khaliq, O.; Latif, M.; Hanif, M., A comprehensive heterogeneous electron transfer rate constant evaluation of dissolved oxygen in DMSO at glassy carbon electrode measured by different electrochemical methods. Journal of Electroanalytical Chemistry 2016, 775, 157-162.

What is claimed is:

1. A non-aqueous redox flow battery comprising:
a negative electrode disposed within a non-aqueous liquid negative electrolyte tank;
a positive electrode disposed within a non-aqueous liquid positive electrolyte tank;
a semi-permeable membrane interposed between said non-aqueous liquid negative electrolyte tank and said non-aqueous liquid positive electrolyte tank; and
wherein at least one of said non-aqueous liquid negative electrolyte tank or said non-aqueous liquid positive electrolyte tank comprises POV-alkoxide clusters.

2. The non-aqueous redox flow battery of claim 1, wherein at least one of said non-aqueous liquid negative electrolyte tank or said non-aqueous liquid positive electrolyte tank comprises 6-V₆O₇(OEt)₁₂.

3. The non-aqueous redox flow battery of claim 2, wherein there is substantially no decomposition of an active species throughout a cycling of said 6-V₆O₇(OEt)₁₂.

4. The non-aqueous redox flow battery of claim 1, wherein a substitution of a bridging alkoxide moieties of methoxide provides enhanced solubility of a metal oxide cluster.

5. The non-aqueous redox flow battery of claim 1, wherein a substitution of a bridging alkoxide moieties of ethoxide provides enhanced stability.

6. The non-aqueous redox flow battery of claim 1, wherein a stability of POV-alkoxide clusters is controlled by a facile alkoxide substitution which substantially preserves a multi-electron redox activity of a hexavanadate core.

7. The non-aqueous redox flow battery of claim 6, wherein a substitution of bridging ethoxide ligands of 6-V₆O₇(OEt)₁₂ enhances electrochemical properties of said hexavanadate core, resulting in a substantially stable charge carrier.

8. The non-aqueous redox flow battery of claim 1, wherein a hexavanadate cluster substantially prevents membrane crossover.

9. The non-aqueous redox flow battery of claim 8, wherein said hexavanadate cluster comprises a plurality of POV-alkoxide clusters which are substantially resistant to membrane crossover.

10. The non-aqueous redox flow battery of claim 9, wherein said POV-alkoxide clusters comprise a ligand substitution from methoxide to ethoxide.

11. The non-aqueous redox flow battery of claim 1, wherein a battery cell efficiency is improved by a ligand substitution of bridging alkoxides on a self-assembled cluster.

12. The non-aqueous redox flow battery of claim 1, wherein a plurality of POV-alkoxide clusters cycle two electrons at both said positive electrode and said negative electrode.

13. The non-aqueous redox flow battery of claim 1, comprising a plurality of POV-alkoxide clusters manufactured by a one-step synthesis process.
